(19) United States
(12) Patent Application Publication
(10) Pub. No.: US 2026/0203925 A1
(43) Pub. Date: Jul. 16, 2026

(54) METHOD, APPARATUS, AND COMPUTER-READABLE MEDIUM FOR FOREGROUND OBJECT DELETION AND INPAINTING

(71) Applicant: GEOMAGICAL LABS, INC., Palo Alto, CA (US)

(72) Inventors: Prakhar Kulshreshtha, Palo Alto, CA (US); Konstantinos Nektarios Lianos, San Francisco, CA (US); Brian Pugh, Mountain View, CA (US); Luis Puig Morales, Seattle, WA (US); Ajaykumar Unagar, Palo Alto, CA (US); Michael Otrada, Campbell, CA (US); Angus Dorbie, Redwood City, CA (US); Benn Herrera, San Rafael, CA (US); Patrick Rutkowski, Jersey City, NJ (US); Qing Guo, Santa Clara, CA (US); Jordan Braun, Berkeley, CA (US); Paul Gauthier, San Francisco, CA (US); Philip Guindi, Mountain View, CA (US); Salma Jiddi, San Francisco, CA (US); Brian Totty, Los Altos, CA (US)

(21) Appl. No.: 19/563,875

(22) Filed: Mar. 11, 2026

Related U.S. Application Data
(63) Continuation of application No. 18/213,091, filed on Jun. 22, 2023, now abandoned.
(63) Continuation-in-part of application No. 19/066,920, filed on Feb. 28, 2025.
Application No. 19/066,920 is a continuation of application No. 18/337,637, filed on Jun. 20, 2023, now Pat. No. 12,272,085.
Application No. 18/337,637 is a continuation of application No. 17/096,814, filed on Nov. 12, 2020, now Pat. No. 11,727,587.
(60) Provisional application No. 62/934,387, filed on Nov. 12, 2019.
(60) Provisional application No. 63/354,596, filed on Jun. 22, 2022.
(60) Provisional application No. 63/354,608, filed on Jun. 22, 2022.

(51) Int. Cl. G06T 7/60; G06T 3/18; G06T 5/77; G06T 7/12; G06T 7/13; G06T 7/194; G06T 7/50; G06T 7/536; G06V 10/764; G06V 20/70

(52) U.S. Cl. CPC G06T 7/60; G06T 3/18; G06T 5/77; G06T 7/12; G06T 7/13; G06T 7/194; G06T 7/50; G06T 7/536; G06V 10/764; G06V 20/70; G06T 2207/10024; G06T 2207/20164; G06V 2201/07

(57) ABSTRACT

A method, apparatus, and computer-readable medium for foreground object deletion and inpainting, including storing contextual information corresponding to an image of a scene, identifying one or more foreground objects in the scene based at least in part on the contextual information, each foreground object having a corresponding object mask, identifying at least one foreground object in the one or more foreground objects for removal from the image, generating a removal mask corresponding to the at least one foreground object based at least in part on at least one object mask corresponding to the at least one foreground object, determining an estimated geometry of the scene behind the at least one foreground object based at least in part on the contextual information, and inpainting pixels corresponding to the removal mask with a replacement texture omitting the foreground object based at least in part on the estimated geometry of the scene.

### RELATED APPLICATION DATA

This application is a continuation-in-part of U.S. Nonprovisional application Ser. No. 19/066,920, filed Feb. 28, 2025, which is a continuation of U.S. Nonprovisional application Ser. No. 18/337,637, filed Jun. 20, 2023, now U.S. Pat. No. 12,272,085, issued Apr. 8, 2025, which is continuation of U.S. Nonprovisional patent application Ser. No. 17/096,814, filed Nov. 12, 2020, now U.S. Pat. No. 11,727,587, issued Aug. 15, 2023, which itself claims priority to U.S. Provisional Application No. 62/934,387, filed Nov. 12, 2019, disclosures of which are hereby incorporated herein by reference in their entirety.

This application is also a continuation of U.S. Nonprovisional application Ser. No. 18/213,091, filed Jun. 22, 2023, which itself claims priority to U.S. Provisional Application No. 63/354,596, filed Jun. 22, 2022, and U.S. Provisional Application No. 63/354,608, filed Jun. 22, 2022, the disclosures of which are hereby incorporated by reference in their entirety.

### BACKGROUND

The ability to remove objects from a scene is a common task in applications like image editing, augmented reality, and diminished reality. The removal of objects from a scene necessitates replacing the missing portion of the scene with the appropriate background geometric structures, textures, objects, etc. This replacement of missing or removed portions of the scene is referred to as inpainting.

The general problem of image inpainting has seen many improvements over the past few decades in both classical and deep learning approaches. While modern inpainting techniques work for small to medium sized regions, they struggle to produce convincing results for larger missing segments. For these regions, the texture and structure from surrounding areas fails to propagate in a visually pleasing, and physically plausible way. Inpainting large regions requires geometric, texture, and lighting consistency to produce convincing results. State-of-the-art inpainting networks often fail to complete large global structures, such as the plausible continuation of walls, ceilings, and floors in an indoor scene.

Accordingly, there is a need for improvements in systems and foreground object deletion and inpainting.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example of an input image and a masked version of the image that masks the foreground objects.

FIG. 2 illustrates examples of inpainting using prior methods of inpainting, including inpainting with fourier convolutions, inpainting with neural networks, and inpainting with diffusion models.

FIG. 3A illustrates an application of the methods described herein to erase furniture from a scene according to an exemplary embodiment.

FIG. 3B illustrates an example of the process of removing and adding new furniture to a scene according to an exemplary embodiment.

FIG. 4 illustrates a flowchart of a method for foreground object deletion and inpainting according to exemplary embodiment.

FIG. 5 illustrates a system chart illustrating the process for generating contextual information according to an exemplary embodiment.

FIGS. 6A-6G illustrate different types of contextual information that can be part of the output produced by the input preprocessor or input to the system according to an exemplary embodiment.

FIG. 7 illustrates a flowchart for identifying additional instance segments for removal according to an exemplary embodiment.

FIG. 8 illustrates a flowchart for identifying one or more foreground objects according to an exemplary embodiment.

FIG. 9 illustrates an example of foreground object identification according to an exemplary embodiment.

FIG. 10 illustrates a flowchart for identifying at least one foreground object for removal from the image according to an exemplary embodiment.

FIG. 11 illustrates an example of a user selecting at least one foreground object for removal from the image according to an exemplary embodiment.

FIG. 12 illustrates an example of combining foreground objects according to an exemplary embodiment.

FIG. 13 illustrates a flowchart for generating a removal mask corresponding to the at least one foreground object based at least in part on at least one object mask corresponding to the at least one foreground object according to an exemplary embodiment.

FIG. 14 illustrates an example of a furniture mask corresponding to all foreground objects in the scene according to an exemplary embodiment.

FIG. 15 illustrates an example combining object masks corresponding to multiple foreground masks into a compound object mask according to an exemplary embodiment.

FIG. 16 illustrates an example of combining at least a portion of a shadow mask with at least one object mask corresponding to the at least one foreground object according to an exemplary embodiment.

FIG. 17 illustrates an example of dilating a furniture/object mask according to an exemplary embodiment.

FIG. 18 illustrates the dilated furniture mask and the portion of the mask corresponding to the dilated portion according to an exemplary embodiment.

FIG. 19 illustrates an example of using shadow cues to adjust a dilated object mask according to an exemplary embodiment.

FIG. 20 illustrates a flowchart for using the shadow mask with a dilated object mask to produce a variably dilated/inflated mask according to an exemplary embodiment.

FIG. 21 illustrates a flowchart for determining an estimated geometry of the scene behind the at least one foreground object according to an exemplary embodiment.

FIG. 22 illustrates an example of using depth information and a semantic map to identify a plurality of planes according to an exemplary embodiment.

FIG. 23 illustrates an example of determining one or planes behind a foreground object based at least in part on plane masks and a location of the foreground object and determining an estimated geometry of the planes behind the foreground object based at least in part on plane equations according to an exemplary embodiment.

FIG. 24 illustrates an example of finding texture regions using plane masks according to an exemplary embodiment.

FIG. 25 illustrates a flowchart for generating a regions mask according to an exemplary embodiment.

FIG. 26 illustrates another flowchart for generating a regions mask according to an exemplary embodiment.

FIGS. 27A-27C illustrate examples of the input and output of the segmentation and geometry determination processes described herein according to an exemplary embodiment.

FIG. 28 illustrates a flowchart for inpainting pixels corresponding to the removal mask with a replacement texture omitting the at least one foreground object based at least in part on the estimated geometry of the scene behind the at least one foreground object according to an exemplary embodiment.

FIG. 29 illustrates a flowchart for inpainting a set of pixels corresponding to at least a portion of the removal mask that overlaps the plane according to an exemplary embodiment.

FIG. 30 illustrates a diagram showing how homography mappings are obtained according to an exemplary embodiment.

FIG. 31 illustrates an example of using multiple homographies to infill large planes according to an exemplary embodiment.

FIG. 32 illustrates an example of inpainting by extracting texture regions per plane and inpainting the background/layout planes based on extracted texture regions according to an exemplary embodiment.

FIG. 33 illustrates an example of inpainting with a grid pattern according to an exemplary embodiment.

FIG. 34 illustrates an example of inpainting with a grid pattern and homography rectification/mappings according to an exemplary embodiment.

FIG. 35 illustrates an example of inpainting with a neural network according to an exemplary embodiment.

FIG. 36 illustrates an example of inpainting with a neural network and homography rectification/mappings according to an exemplary embodiment.

FIG. 37 illustrates an example of neural network based inpainting and gray artifacts according to an exemplary embodiment.

FIG. 38 illustrates the operation of the neural network feature refinement software according to an exemplary embodiment.

FIG. 39 illustrates an example of neural network based inpainting using the disclosed feature refinement software according to an exemplary embodiment.

FIG. 40 illustrates an example of inpainting a masked image with histogram refinement, multi-scale refinement, and histogram plus multi-scale refinement according to an exemplary embodiment.

FIG. 41 illustrates an example of the operation of the inpainting neural network according to an exemplary embodiment.

FIG. 42 illustrates an example of guided inpainting of non-planar areas according to an exemplary embodiment.

FIG. 43 illustrates an example of boundary sharpness inpainting according to an exemplary embodiment.

FIG. 44 illustrates an example of filtered and inflated instances for inpainting according to an exemplary embodiment.

FIG. 45 illustrates an example of blending the inpainted texture according to an exemplary embodiment.

FIG. 46 illustrates an example of a furniture eraser feature according to an exemplary embodiment.

FIG. 47 illustrates an example of a furniture eraser feature interface according to an exemplary embodiment.

FIG. 48 illustrates an example of erasing Manhattan constraints instances according to an exemplary embodiment.

FIG. 49 illustrates an example of a conventional brush tool.

FIG. 50 illustrates an example of a brush tool according to an exemplary embodiment.

FIG. 51 illustrates another example of the application of the brush tool according to an exemplary embodiment.

FIG. 52 illustrates an example of a user brush tool usage according to an exemplary embodiment.

FIG. 53 illustrates an example of inpainting with stackable objects according to an exemplary embodiment.

FIG. 54 illustrates an example of inpainting with wall decor according to an exemplary embodiment.

FIG. 55 illustrates an example of inpainting with intrinsic image decomposition according to an exemplary embodiment.

FIG. 56 illustrates a flowchart of inpainting with intrinsic image decomposition according to an exemplary embodiment.

FIG. 57 illustrates an example of inpainting and background color editing according to an exemplary embodiment.

FIG. 58 illustrates an example of inpainting and auto-decoration according to an exemplary embodiment.

FIG. 59 illustrates a high level flowchart for a client brush tool incorporating the described foreground object deletion and inpainting methods according to an exemplary embodiment.

FIG. 60 illustrates a high level flowchart for foreground object deletion and inpainting according to an exemplary embodiment.

FIG. 61 illustrates a flowchart for inpainting a room according to an exemplary embodiment.

FIG. 62 illustrates an example of incoherence introduced by inpainting according to an exemplary embodiment.

FIG. 63 illustrates qualitative examples from an inpainting test set according to an exemplary embodiment.

FIG. 64 illustrates the components of a specialized computing environment configured to perform the processes described herein according to an exemplary embodiment.

### DETAILED DESCRIPTION

While methods, apparatuses, and computer-readable media are described herein by way of examples and embodiments, those skilled in the art recognize that methods, apparatuses, and computer-readable media for foreground object deletion and inpainting are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

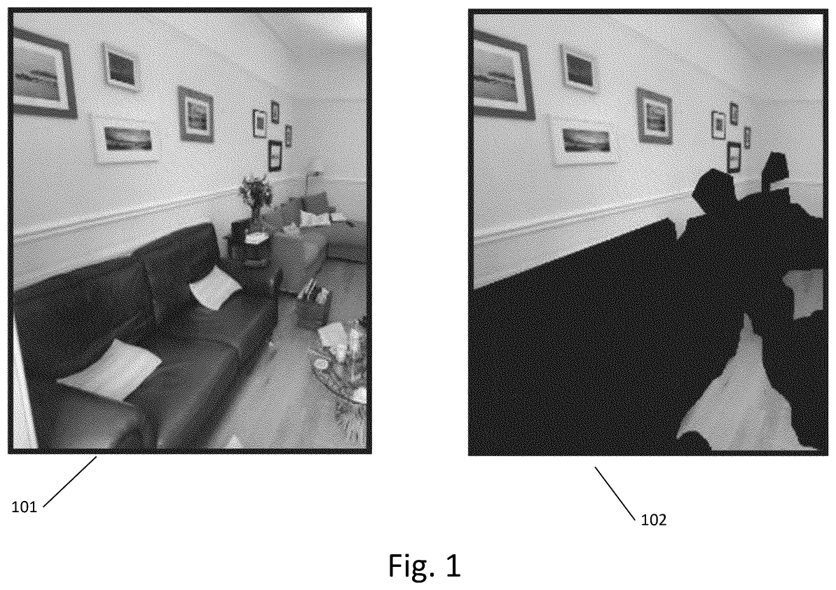

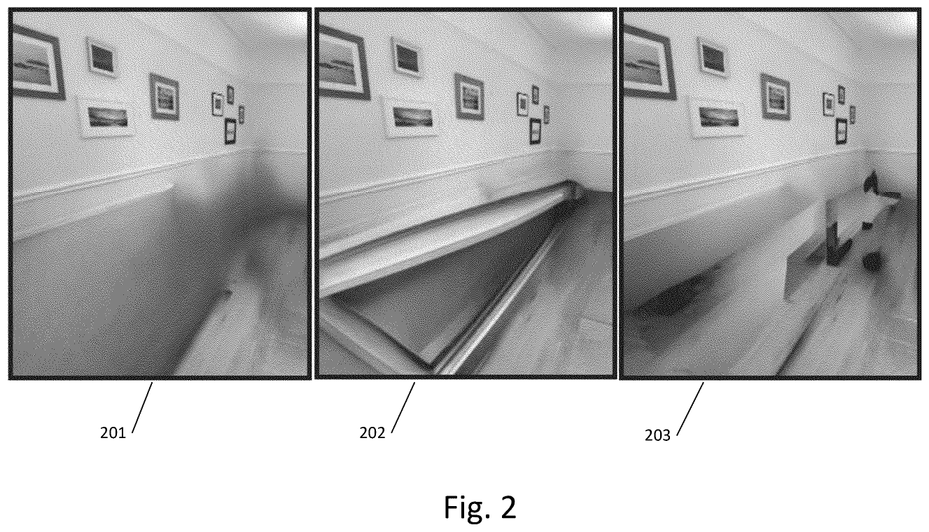

The present system addresses the problem of detecting and erasing foreground objects, such as furniture, from a scene. As explained above, inpainting large regions of an indoor scene often results in geometric inconsistencies of background elements within the inpaint mask. FIG. 1 illustrates an example of an input image 101 and a masked version of the image 102 that masks the foreground objects. FIG. 2 illustrates examples of inpainting using prior methods of inpainting, including inpainting with fourier convolutions 201, inpainting with neural networks 202, and inpainting with diffusion models 203. As shown in FIG. 2, the inpainting results are blurry, color inconsistent, and hallucinate new unwanted structures.

The present system addresses these problems by utilizing contextual/perceptual information (e.g. instance segmentation, and room layout) to produce a geometrically consistent empty version of a room.

The disclosed methods and techniques are described in the context of an interior design system. Mixed reality technologies are proving to be promising ways to help people reimagine rooms with new furnishings. One problem with mixed reality solutions is that existing furniture in the scene (that a user may wish to replace) interferes with the reimagined room.

The present system allows users of mixed reality space imagination solutions to “erase” imagery of physical furniture they no longer want, in order to allow users to reuse occupied space. In particular, Applicant has developed a method to conveniently erase furniture from mixed reality representations of spaces, with interactive performance, while maintaining realistic coherence of geometry, imagery, and shading, that is sufficient to allow reimagining of the space.

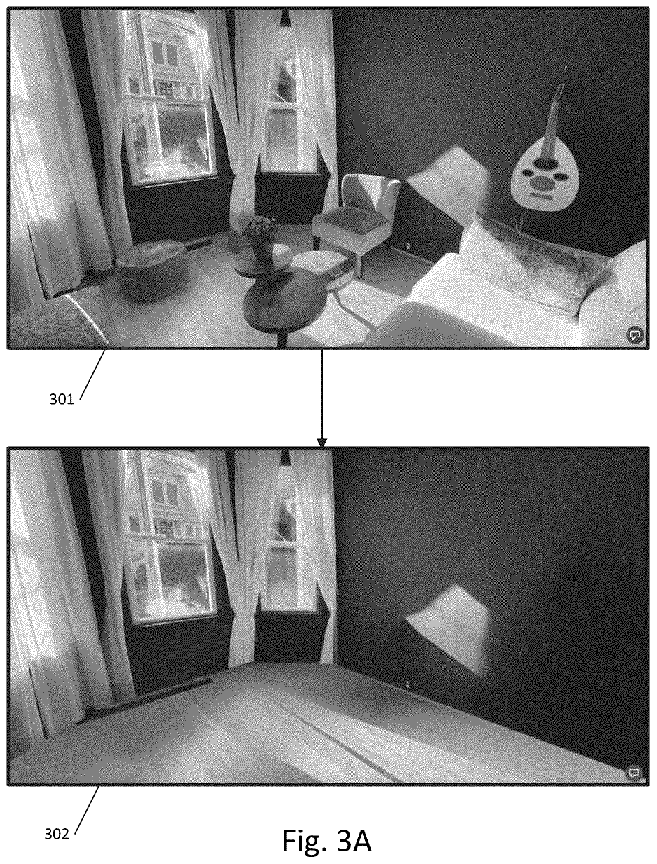

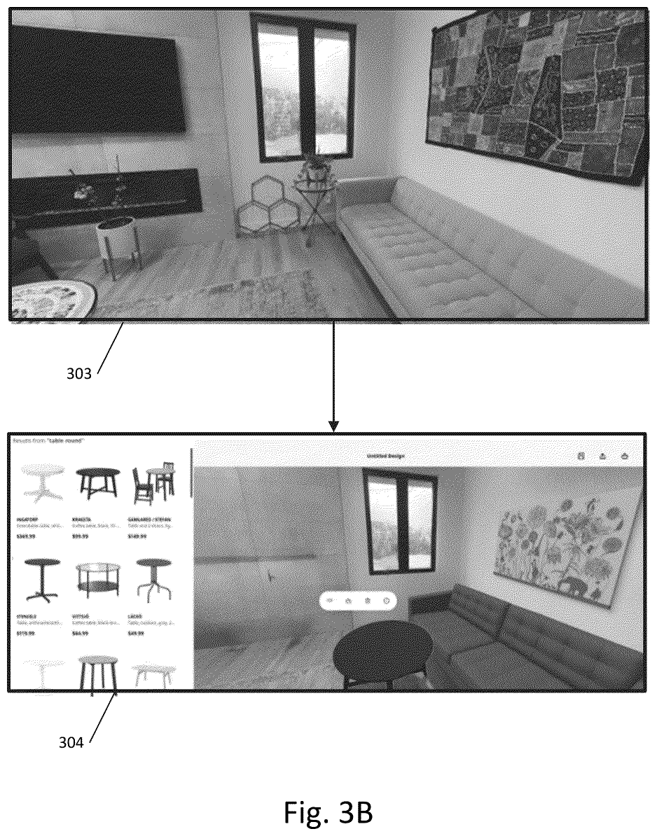

Applicant has developed a method to conveniently erase furniture from mixed reality representations of spaces, with interactive performance, while maintaining realistic coherence of geometry, imagery, and shading, that is sufficient to allow reimagining of the space. FIG. 3A illustrates an application of the methods described herein to erase furniture from a scene according to an exemplary embodiment. An input image 301 illustrates a scene, including furniture and other foreground objects. As shown in image 302, the foreground objects and furniture have been removed from the scene and the portions of the scene corresponding to the removed objects have been inpainted in a convincing manner. As used herein, foreground objects can include any objects other than the background walls, doors, ceilings, windows, etc. Foreground objects can include, for example, furniture, tables, light fixtures, wall hangings, curtains, objects on surfaces, etc.

The methods described herein can be implemented in a user facing system. A user can take a photo or multiple photos of a space showing a scene (e.g., a room in their house). Using the techniques described in greater detail below, different aspects of the scene can be modeled. Once this modeling is complete, a user can:
Select a furniture item or other foreground object in the scanned room (e.g., by hovering over its photographic representation);
Erase the foreground object from the Red-Green-Blue (RGB) image;
Reset the geometric surfaces of the removed object to prevent occlusion;
Refine shadow and lighting artifacts from the erased object; Put a new virtual object in its place.

The user-facing application can also implement an “erase-all” function which enables users to empty an entire room/scene in an image all at once, as shown in FIG. 3A.

The present method and system makes it easy to select objects to erase (or ranges or portions of objects), replace the geometry and imagery of the removed objects with a believable representation of the space behind the object, and remove the shadow and lighting impacts of the erased object.

Features of the system include:
Making it easy to select furniture pixels to “erase,” ideally allowing selection and deletion of entire objects;
Preventing “erased” pixels from occluding newly-added furniture items;
Resetting the 3D geometry of the “erased” pixels, replacing with the likely 3D surfaces behind the erased object, so geometric placement on floor, wall, etc. behind the erased object is physically consistent;
Replacing “erased” pixels with substitute pixels that look realistically suggestive of likely surfaces behind the deleted object, or at least indicative of a deleted object;
Adjusting shadows & lighting, to reduce cast shadows and reflected lighting from objects that have been removed.

FIG. 3B illustrates an example of the process of removing and adding new furniture to a scene according to an exemplary embodiment. The furniture in the original image 303 of the scene is removed and new furniture is inserted into the scene, as shown in 304.

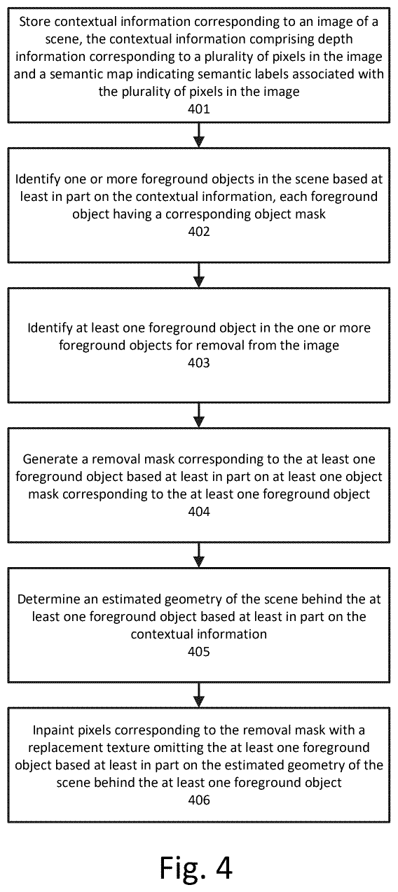

FIG. 4 illustrates a flowchart of a method for foreground object deletion and inpainting according to exemplary embodiment. The method can be performed on a server that interfaces with a client and having sufficient computing resources to perform the graphics, modeling, and machine learning tasks described herein. Alternatively, the method can be performed on a client device having sufficient resources or performed on a computing device or set of computing devices outside of a client-server system.

Prior to the initial step, a user can capture and upload one or more images of a scene. The image or images are then processed and analyzed to extract or determine the contextual information described below and/or perceptual information. This can include, for example, 3D points, features, gravity, augmented reality data, etc. The image or images can be further processed to extract layout information, as described in greater detail below.

Although the described method can perform foreground object deletion and inpainting from a single image and single view of a scene, the process can be enhanced when multiple images and multiple viewpoints are provided. When multiple views are provided, the scene/room can be scanned from multiple vantage points, allowing visibility of foreground objects from their sides and more accurate geometry estimation of foreground objects, as well as views behind foreground objects. The additional data derived from additional viewpoints and images also allows for improvements in nesting of objects and deletion of objects. For example, when multiple foreground objects are nested in front of each other and block each other from one vantage point, multiple viewpoints can allow for inpainting which does not delete all objects when inpainting but rather allows for deletion of just one of the objects (i.e., the foremost object) and inpainting using the other foreground objects. Multiple views and images also allow for building better three dimensional views of objects and provide additional views of geometry and textures that can be used for replacement pixels, to better guide the inpainting process.

At step 401 contextual information corresponding to an image of a scene is stored, the contextual information comprising depth information corresponding to a plurality of pixels in the image and a semantic map indicating semantic labels associated with the plurality of pixels in the image.

The depth information corresponding to the plurality of pixels in the image can include, for example, a dense depth map corresponding to the plurality of pixels, a sparse depth map corresponding to the plurality of pixels, a plurality of depth pixels storing both color information and depth information, a mesh representation corresponding to the plurality of pixels, a voxel representation corresponding to the plurality of pixels, depth information associated with one or more polygons corresponding to the plurality of pixels, or three dimensional geometry information corresponding to the plurality of pixels.

For example, the system can store a three dimensional geometric model corresponding to the scene or a portion of the scene. The three dimensional geometric model can store x, y, and z coordinates for various structures in the scene. These coordinates can correspond to depth information, since the coordinates can be used with camera parameters to determine a depth associated with pixels in an image viewed from the camera orientation.

The contextual information can further include a gravity vector corresponding to the scene, an edge map corresponding to a plurality of edges in the scene, a shadow mask corresponding to a plurality of shadows in the scene, a normal map corresponding to a plurality of normals in the scene, an instance map indicating a plurality of instance labels associated with the plurality of pixels in the image, and/or a plurality of object masks corresponding to a plurality of objects in the scene. Contextual information also includes camera parameters, including intrinsic parameters such as focal length, radial distortion and settings such as exposure, color balance, etc.

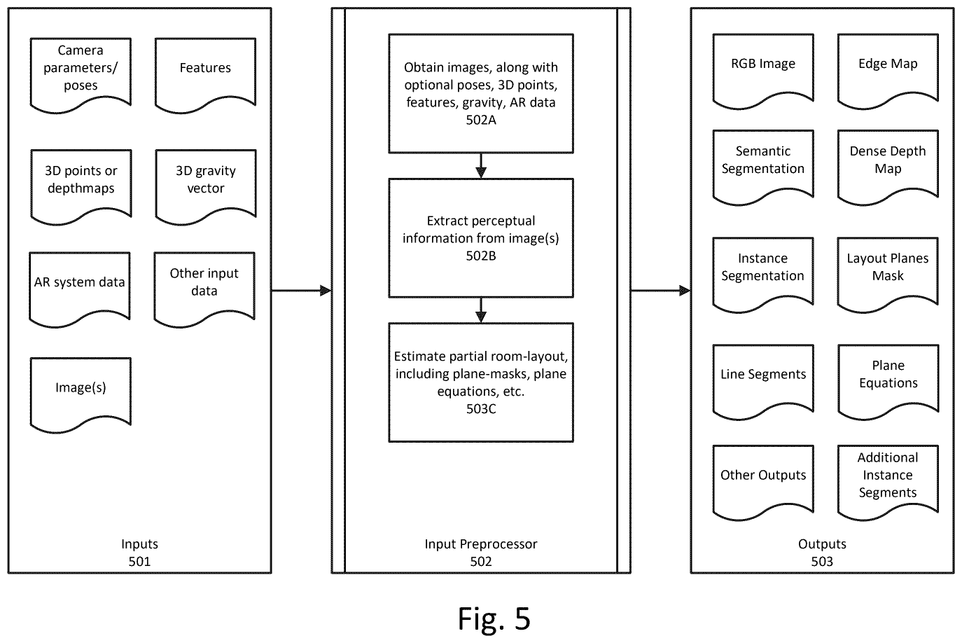

FIG. 5 illustrates a system chart illustrating the process for generating contextual information according to an exemplary embodiment. An input preprocessor 502 can receive inputs 501 and generate outputs 503 corresponding to the contextual/perceptual information. Input preprocessor can be implemented as a set of software functions and routines, with hardware processors and GPUs (graphics processing units), or a combination of the two.

Inputs 501 can include camera poses, features, 3d points and/or depthmaps, 3d gravity vectors, augmented reality system data, one or images, and/or other input data. Of course, these inputs can themselves be generated from other inputs. For example, depthmaps and 3d points can be derived by applying computer vision image processing techniques to the input image or images.

As shown in step 502A, the input preprocessor 502 obtains images, along with optional poses, 3d points, features, gravity information, IMU data streams, and/or augmented reality data. As part of this step, the input preprocessor 502 can obtain one or more images, gravity, camera poses, 3D points or depthmaps, features, and/or AR data. The images can be RGBD (Red-Green-Blue-Depth) images, RGB (Red-Green-Blue) images, RGB images with associated inertial measurement unit (IMU) data streams, and/or RGBD images of a room/space with optional measurement of gravity vector. Of course, any representation of the captured scene (e.g. point clouds, depth-maps, meshes, voxels, where 3D points are assigned their respective texture/color) can be used.

At step 502B perceptual information is extracted from the image. The image captures are used to obtain perceptual quantities, aligned to one or more of the input images, individually or stitched into composite images. These perceptual quantities can include semantic segmentation, instance segmentation, line segments, edge-map, and/or dense depth. The dense depth can be obtained by using dense fusion on RGBD, or by densifying sparse reconstruction from RGB images (such as through neural network depth estimation and multiview stereoscopy). Metric scale is estimated using many methods including multi-lens baseline, active depth sensor, visual-inertial odometry, SLAM (Simultaneous Localization and Mapping) points, known object detection, learned depth or scale estimation, manual input, or other methods. In this step a set of one or more images, with (optionally) information about gravity, poses, and depths is used to extract various perceptual information like semantic segmentation, edges, and others, using task-specific classical/deep-learning algorithms. The perceptual information can be aligned to one or more of the input images, or to a composed input image e.g. a stitched panorama.

At step 502C a partial room-layout can be estimated, including plane-masks, plane equations, non-planar geometry, and other architectural layout information. This layout estimation system which utilizes the perceptual information to identify one or more of the wall, floor, and ceiling planes. As discussed below, the output of these steps can include a plane-mask aligned to the image(s) of interest, along with the 3D equation for each of the planes. In this step, the perceptual information extracted in 502B can be used to estimate the room layout using planes, with planes for walls, floors, and ceilings. Each of these planes can be represented by, for example, a 3D plane equation with respect to the pose of the image of interest, and a binary mask, which is 1 for all pixels corresponding to this plane (wall/floor/ceiling) in the image(s) of interest and 0 for all other pixels.

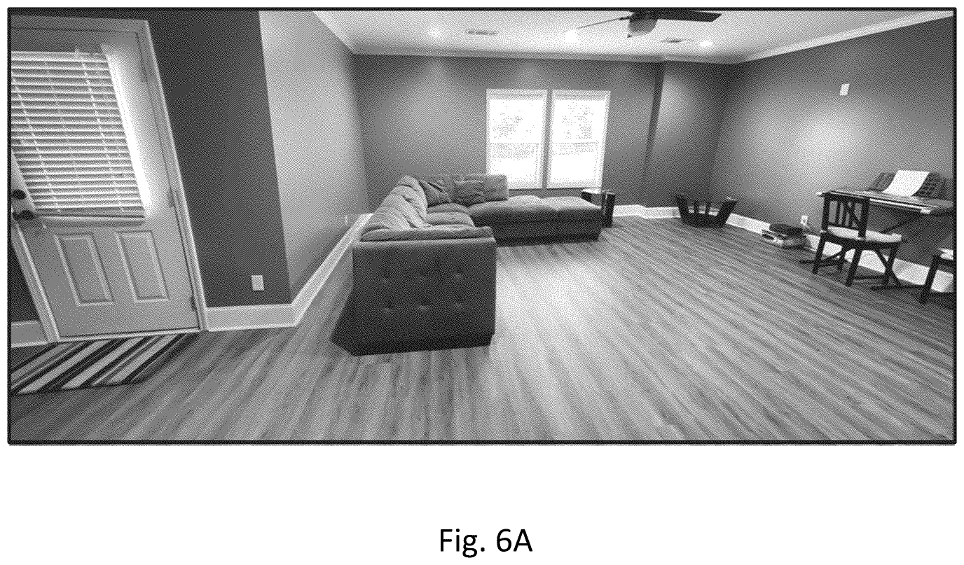

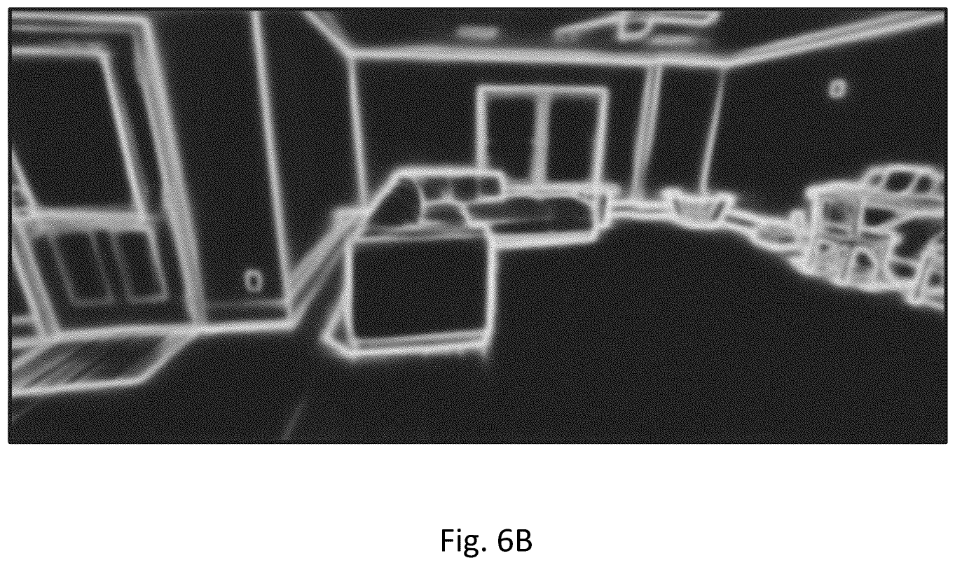

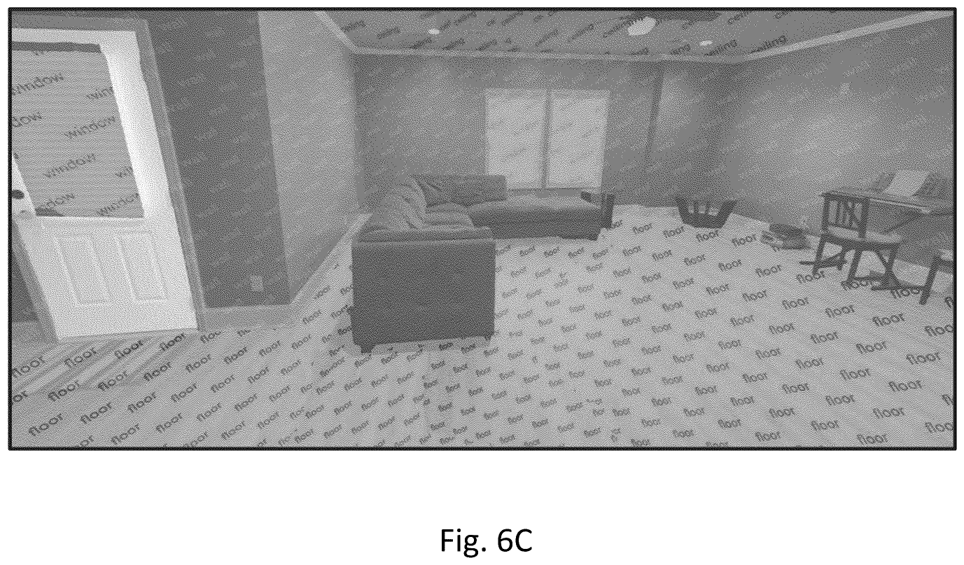

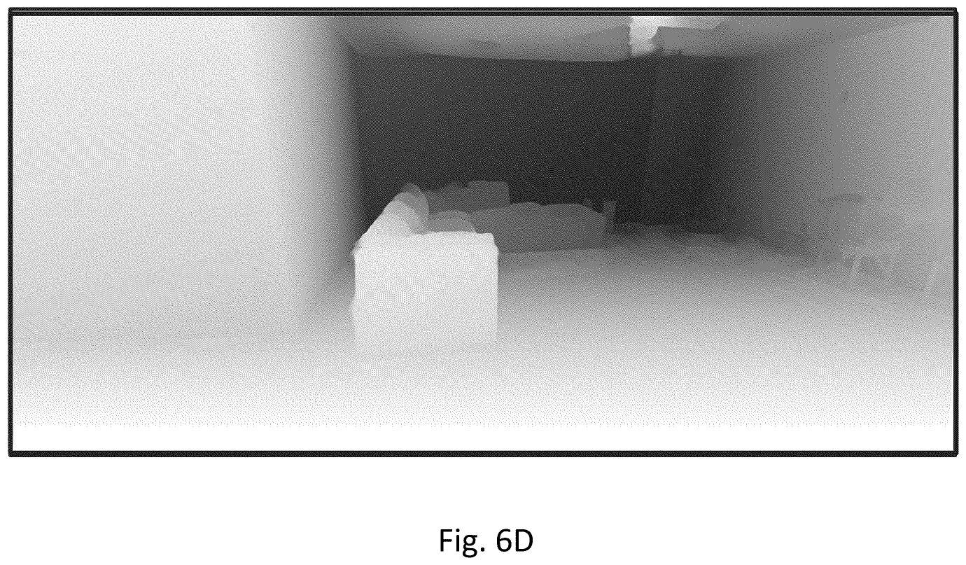

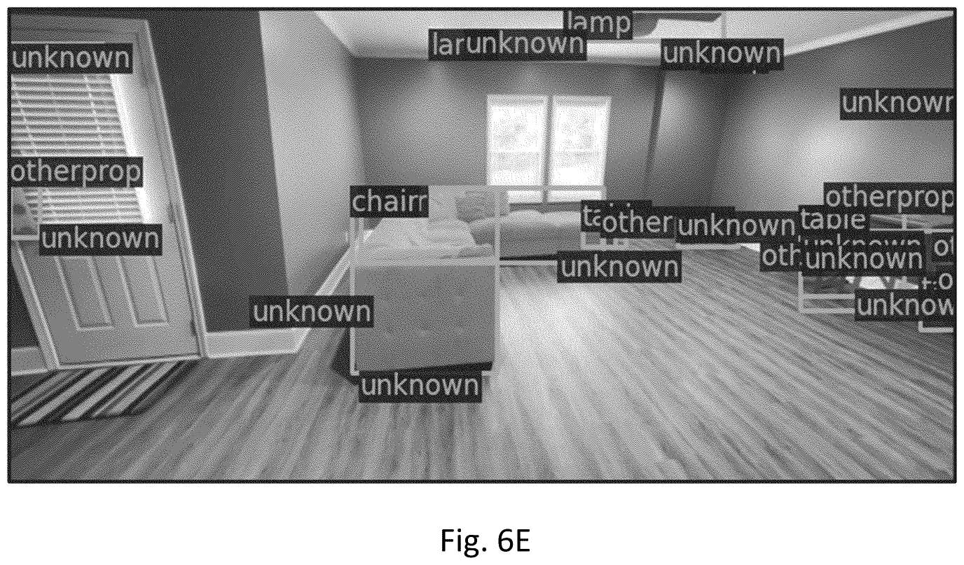

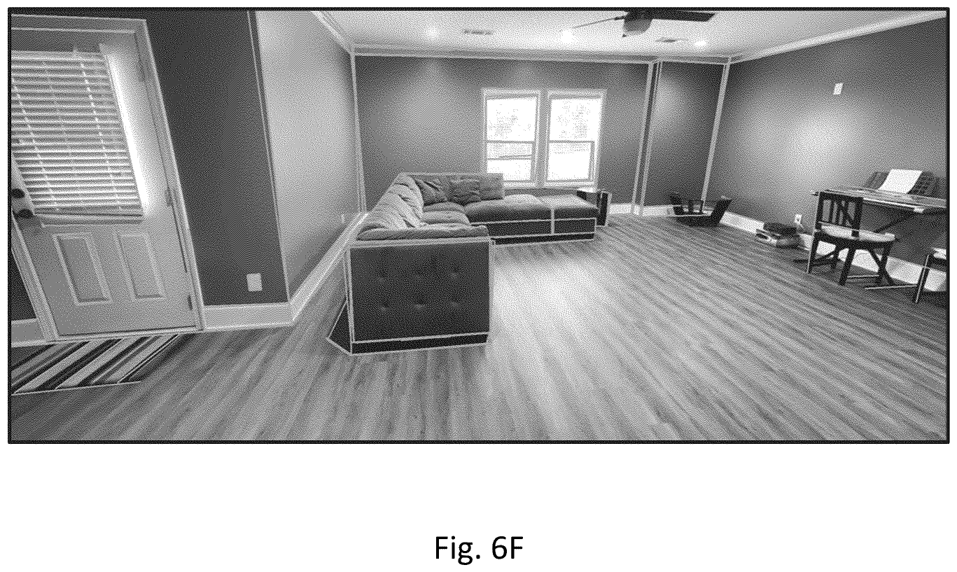

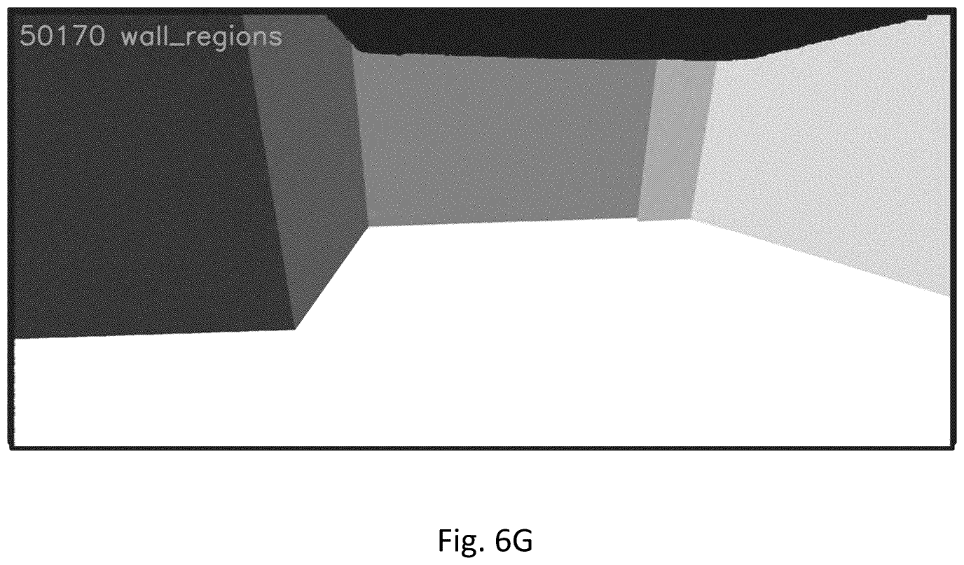

The outputs 503 of preprocessor 502 and inputs 501 can include variety of contextual and perceptual information. Outputs 503 can include, for example, an RGB image (passed through from input and/or modified by preprocessor), an edge map, semantic segmentation and/or a semantic map, a dense depth map, instance segmentation and instance segments, a layout planes mask, line segments, plane equations, instance segment additions, and other outputs. Several of the outputs are described further with respect to FIGS. 6A-6G, discussed below.

FIGS. 6A-6G illustrate different types of contextual information that can be part of the output produced by the input preprocessor or input to the system according to an exemplary embodiment. FIG. 6A illustrates an image of a scene. This image can be the image provided by a user or a refined or otherwise modified version of the image. FIG. 6B illustrates an edge map of the scene indicating detected edges in the scene.

FIG. 6C illustrates a semantic map of a scene formed by semantic segmentation of the scene. As shown in FIG. 6C, the pixels in the scene are semantically segmented such each pixel in a plurality of pixels in the image is associated with a semantic label. For example, pixels that form part of a window in the scene can be labeled window, pixels that form part of a wall can be labeled wall, and pixels that form part of the floor can be labeled floor. As shown in FIG. 6C, the pixels that form part of walls, windows, floors, and/or ceilings are semantically labeled. Although not shown in this figure, semantic labels can be used for other aspects of a scene. Semantic labels can include labels corresponding to floors, walls, tables, windows, curtains, ceilings, chairs, sofas, furniture, light fixtures, lamps, and/or other categories of foreground objects.

The semantic map can include three-dimensional semantic maps, in which semantic labels (such as those described above), are associated with three dimensional geometry, such as polygons or voxels. In this case, the semantic map still includes semantic labels associated with a plurality of pixels, when the scene is viewed as an image from the vantage point of a camera, but the semantic map structure itself maps semantic labels to three dimensional structures.

FIG. 6D illustrates a dense depth map of a scene. In a dense depth map, each pixel in a plurality of pixels of the scene can be mapped to a particular depth value. Of course, other types of depth maps can be utilized, as described above, including sparse depth maps, or other depth value. Depth can include forward depth or ray-distance depth.

FIG. 6E illustrates an instance map of a scene produced by instance segmentation. The instance segmentation produces a set of instance masks, each instance map being a binary masks with a value of 1 for each pixel corresponding to a particular foreground object and a value of 0 for each pixel that does not correspond to that particular foreground object. For example, as shown in this figure, an instance mask for the chair corresponds to the instance of the chair/sofa in the picture.

FIG. 6G illustrates a layout map of a scene showing layout planes in the scene. The process for generating the layout map is described in greater detail with respect to 22. Each layout plane corresponds to a background plane, such as wall/window/door plane, a floor plane, and/or a ceiling plane. Each of the layout planes can be stored as segmentation mask for the image(s), the segmentation mask indicating which pixels in the image(s) correspond to a particular plane. 3D plane equations can also be computed for each of the layout planes, with the 3d plane equations defining the orientation of the plane in three-dimensional space. To track this information on a per-plane basis, planes can have corresponding plane identifiers (e.g., wall 1, wall 2, ceiling, etc.) and the plane identifiers can be associated with plane equations for each plane. The layout map can also include structures other than walls, ceilings, and floors, including architectural features of a room such soffits, pony walls, built-in cabinetry, etc.

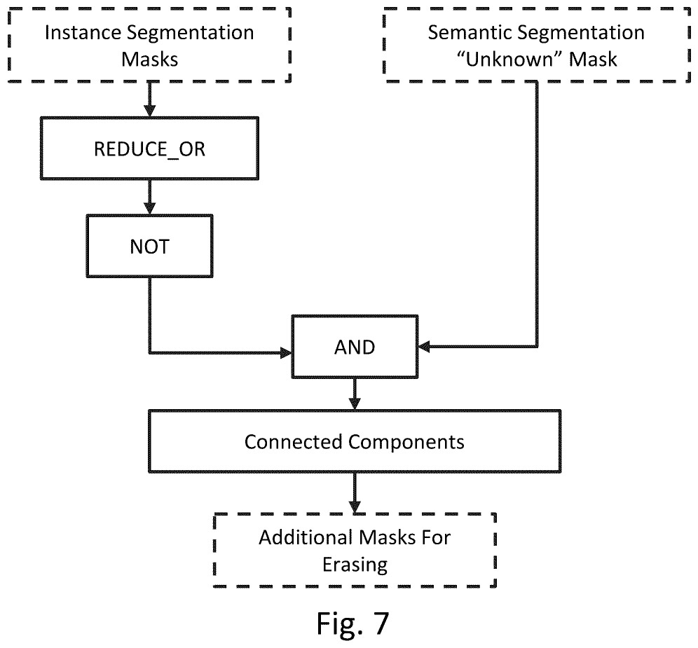

Referring back to FIG. 5, outputs 503 can include additional instance segments. Instance segmentation frequently does not have complete coverage of all items that a user may wish to remove from a room. For example, semantic segmentation will frequently have regions that should be removed segmented as “unknown.” FIG. 7 illustrates a flowchart for identifying additional instance segments for removal according to an exemplary embodiment. As shown in FIG. 7, all detected instances are combined into a single mask by taking the logical- or of them. The mask of “unknown” semantic segmentation that doesn't overlap with the instance-segmentation-masks is then computed. After this, the connected components of the resulting mask are computed and added to the set of instance segmentations.

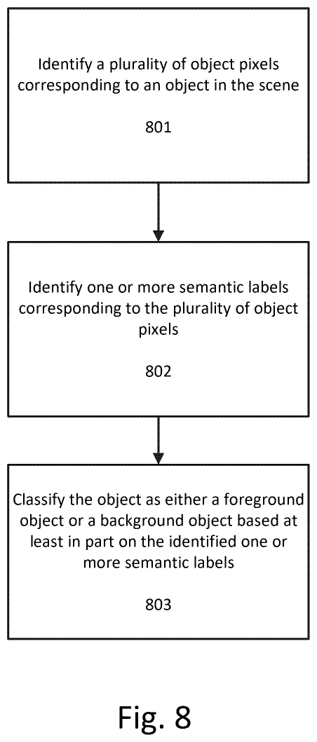

Referring FIG. 4, at step 402 one or more foreground objects in the scene are identified based at least in part on the contextual information. FIG. 8 illustrates a flowchart for identifying one or more foreground objects according to an exemplary embodiment.

At step 801 a plurality of object pixels corresponding to an object in the scene are identified. This step can include identifying all or most of the pixels in an image or images, some of which can correspond to foreground object(s) and some of which can correspond to background features and objects, such as layout planes. Optionally, this step can use pixel sampling from different regions of an image or images to identify regions of pixels in different areas. The previously described instance mask can also be used to identify pixels corresponding to different objects.

At step 802 one or more semantic labels corresponding to the plurality of object pixels are identified. This step can include looking up a semantic labels corresponding to the plurality of object pixels in the semantic map to determine what labels are assigned to the pixels. The semantic map can be superimposed on the object instances or the object pixels identified in step 801 to identify which semantic label corresponds to each of the pixels. This can include, for example, identifying pixels that have a semantic label of wall or identifying pixels that have a semantic label of furniture.

At step 803 the object is classified as either a foreground object or a background object based at least in part on the identified one or more semantic labels. For example, objects including pixels having semantic labels of wall, ceiling, floor, window, or door can be classified as background objects, with remaining objects, such as furniture, sofa, chair, lamp, desk, table, or light fixture, being characterized as foreground objects. A user or administrator can specify which semantic labels correspond to foreground objects and which semantic labels correspond to background objects and may adjust these settings based on application. For example, objects with the semantic label of curtain can be treated as foreground or a background objects.

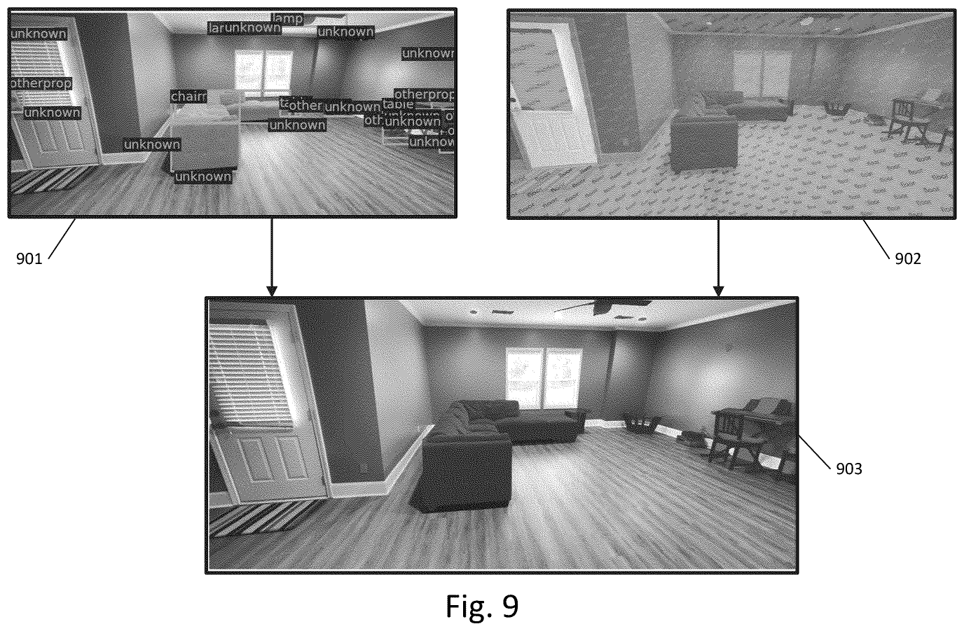

FIG. 9 illustrates an example of foreground object identification according to an exemplary embodiment. As shown in FIG. 9, the semantic map 902 is superimposed with pixels corresponding to object instances (shown, in this example, in instance map 901) in order to identify foreground objects, shown shaded in image 903. Each foreground object has an associated object mask, corresponding to the shading shown in 903.

In this example, all foreground objects have been identified, forming a furniture mask. Depending on the structure of semantic map, the foreground object detection can be a process of elimination or of compiling all foreground objects. For example, if semantic map stores only labels for background objects and layout planes, such as walls, ceilings, and other planes, then the semantic map can be used to determine which pixels are not part of the background. Otherwise, if the semantic map includes labels for all objects, then the object labels can be grouped into foreground and background as discussed above.

Of course, the step of foreground object identification can be performed in other ways and using other forms of contextual information. For example, foreground object identification can be based on one or more of depth information (identifying objects at the front of an image relative to a background or background planes/geometry), three dimensional geometry information (analyzing coordinates in three dimensional space), instance segmentation, pattern/image recognition (recognizing furniture or other objects with or without a neural network), or other techniques.

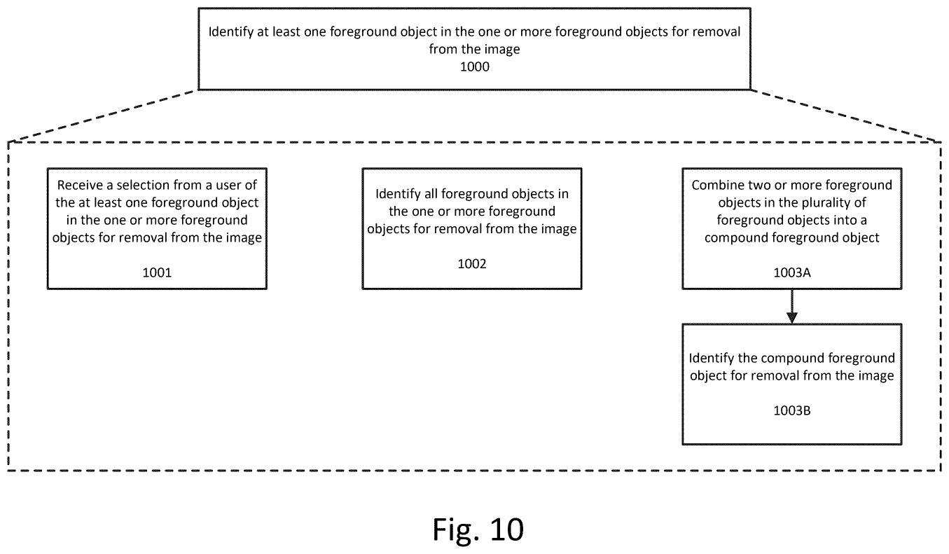

Referring back to FIG. 4, at step 403 at least one foreground object in the one or more foreground objects is identified for removal from the image. FIG. 10 illustrates a flowchart for identifying at least one foreground object for removal from the image according to an exemplary embodiment. As shown in FIG. 10, this step can be performed in multiple different and/or overlapping ways, including step 1001, step 1002, and/or steps 1003A-1003B.

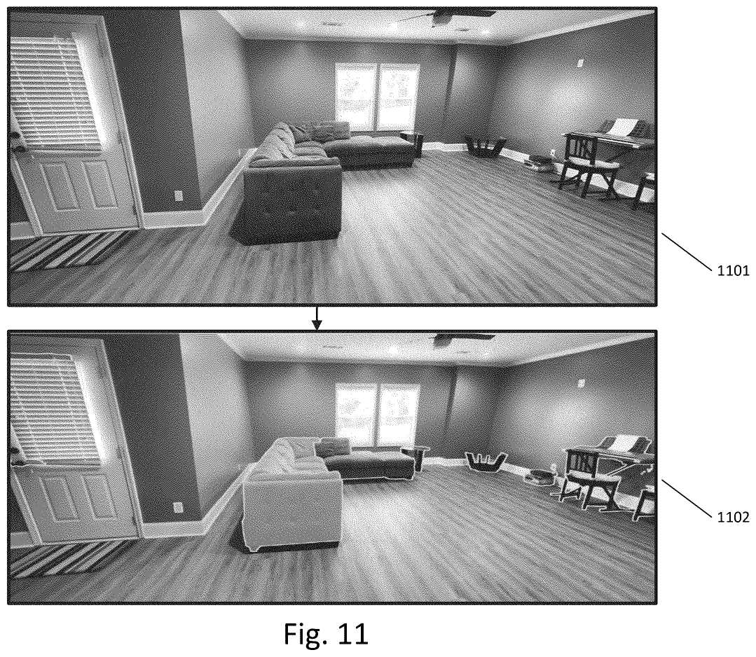

At step 1001 a selection is received from a user of the at least one foreground object in the one or more foreground objects for removal from the image. FIG. 11 illustrates an example of a user selecting at least one foreground object for removal from the image. User is presented with a view of the scene indicating all foreground objects, as shown in 1101. The user then selects the sofa for removal from the scene, as shown in 1102.

At step 1002 all foreground objects in the one or more foreground objects are identified for removal from the image. The user can make a selection of all foreground objects (e.g., via an “empty the room” user interface element) or the default setting can be to automatically identify all foreground objects for removal. An example of all foreground objects being identified for removal is shown in box 903 of FIG. 9.

At step 1003A two or more foreground objects in the plurality of foreground objects are combined into a compound foreground object based at least in part on one or more of: proximity between pixels corresponding to the two or more foreground objects, overlap between pixels corresponding to the two or more foreground objects, or semantic labels corresponding to the two or more foreground objects. In this case, the compound foreground object comprises a compound object mask corresponding to both objects. This technique can be useful when objects are stacked on top of other objects or otherwise merged with other objects (e.g., a vase on a table). It prevents any inaccurate scene modifications or renderings where the underlying object is removed but the connected/stacked object is not removed. For example, if a user were to select a table for removal and leave a vase floating in the air.

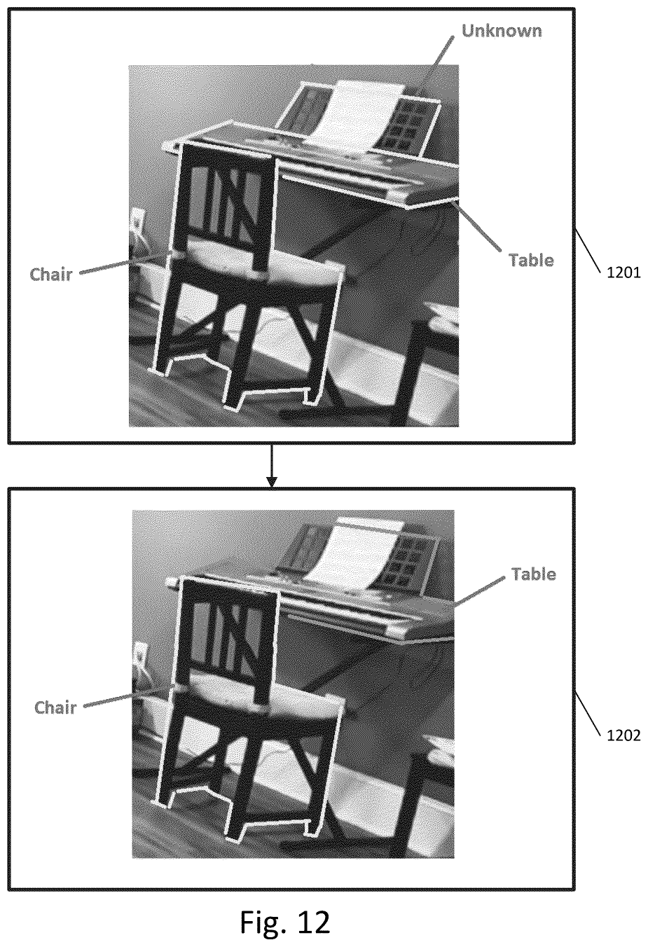

At step 1003B the compound foreground object is identified for removal from the image. The compound foreground object can include two or more objects, such as a table with a lamp, a vase, artwork, or other items. FIG. 12 illustrates an example of steps 1003A-1003B. As shown in box 1201, the chair, the keyboard, and the note sheet have all been identified as separate objects (with semantic labels chair, table, and unknown, respectively). Using the process described in steps 1003A-1003B, the keyboard and note sheet objects are merged into a single compound object, having semantic label “table,” as shown in box 1202.

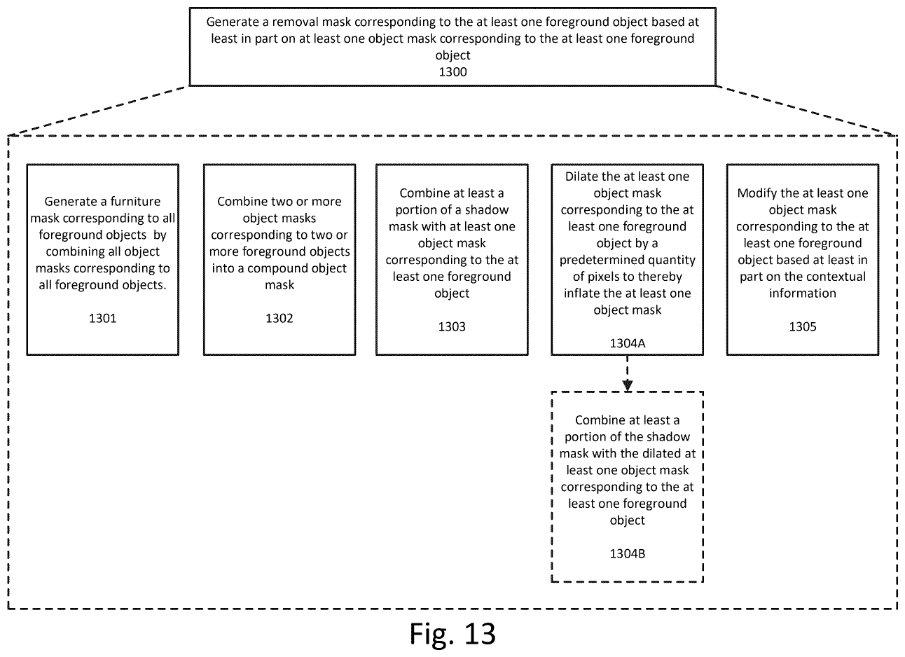

Referring back to FIG. 4, at step 404 a removal mask is generated corresponding to the at least one foreground object based at least in part on at least one object mask corresponding to the at least one foreground object. FIG. 13 illustrates a flowchart for generating a removal mask corresponding to the at least one foreground object based at least in part on at least one object mask corresponding to the at least one foreground object. As shown in FIG. 13, this step can be performed in multiple different and/or overlapping ways, including step 1301, step 1302, step 1303, steps 1304A-1304B, and/or step 1305. These flows and steps can be combined in various different ways. For example, the process of generating a removal mask can include step 1302, steps 1304A-1304B, and 1305.

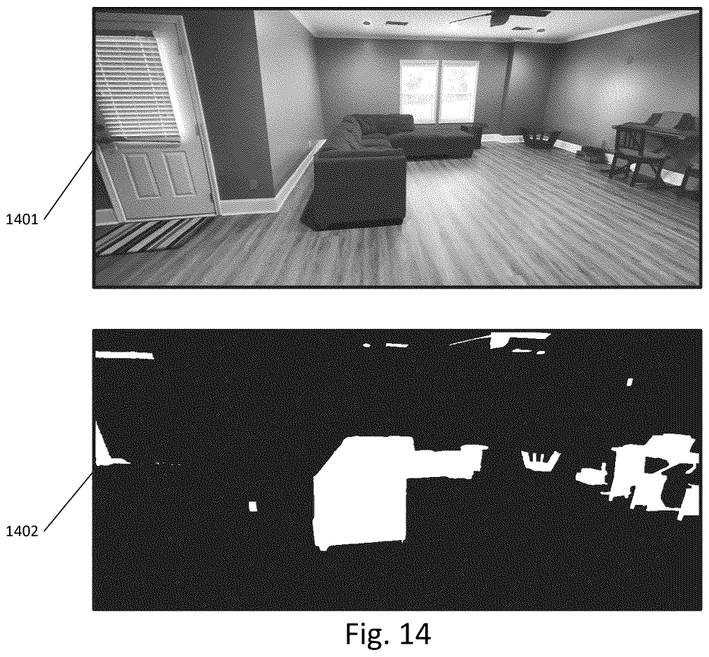

At step 1301 a furniture mask corresponding to all foreground objects in the one or more foreground objects is generated by combining one or more object masks corresponding to the one or more foreground objects. FIG. 14 illustrates an example of a furniture mask corresponding to all foreground objects in the scene according to an exemplary embodiment. The furniture mask is shown at 1402 and the furniture mask is shown superimposed over an RGB image at 1401. The process for creating a furniture mask can include the following steps:
Start with an empty binary mask with all 0s.
For both instance segmentation and semantic segmentation, identify foreground and background categories. E.g. ‘door’, ‘window’, ‘wall’, ‘floor’, ‘curtain’ are considered as background, and rest of the categories, such as ‘chair’, ‘sofa’, ‘unknown’, etc are considered ‘foreground.’
For each of the instances which does not belong to background class (e.g. door, window, etc), we add that into furniture mask, using OR operation. This produces a binary mask which is union of binary masks for all the foreground instances.
Similarly, for each ‘foreground’ semantic segmentation category, add its mask into furniture mask using OR operation.

The result of this process is a furniture mask having all foreground objects.

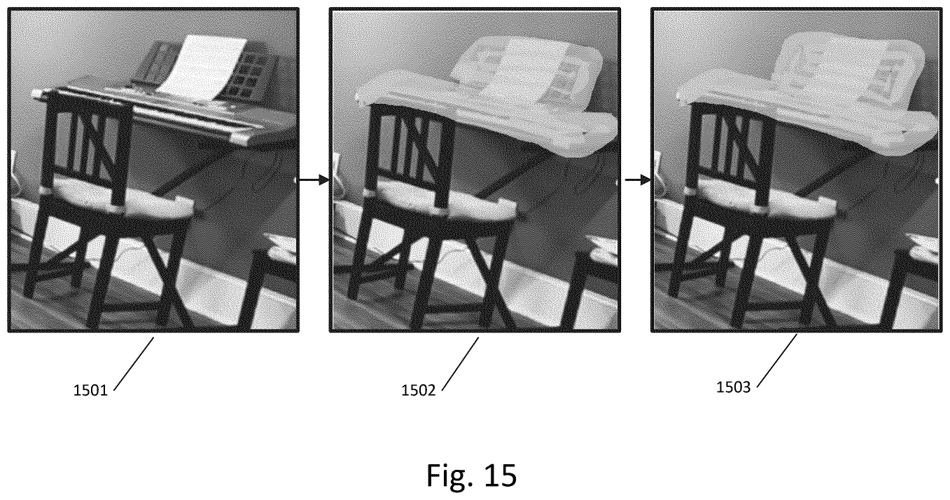

At step 1302 two or more object masks corresponding to the two or more foreground objects are combined into a compound object mask. FIG. 15 illustrates an example combining object masks corresponding to multiple foreground masks into a compound object mask according to an exemplary embodiment. Box 1502 shows the two object masks corresponding to objects shown in RGB image 1501. As shown in box, the two object masks can be combined into a single compound object mask.

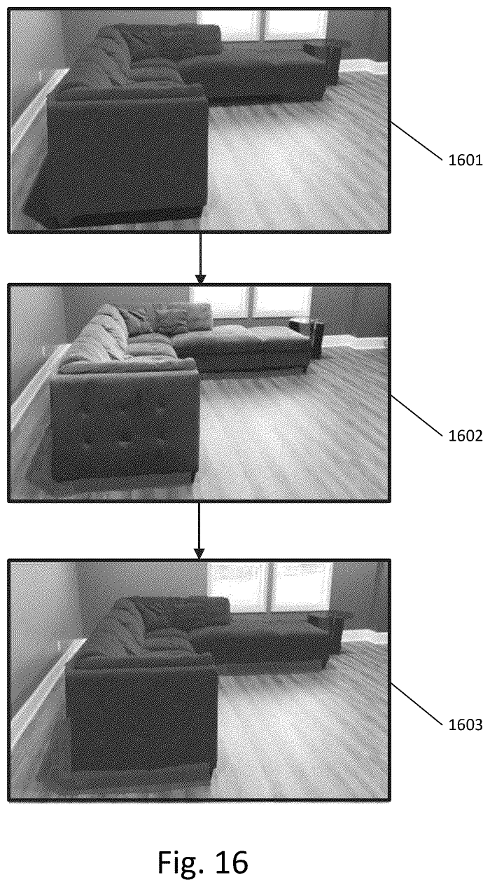

As discussed above, contextual information can include a shadow mask. At step 1303 at least a portion of the shadow mask is combined with the at least one object mask corresponding to the at least one foreground object. It is desirable to remove shadows in addition to objects, as leaving shadows in the image may result in discontinuities and irregularities when the region is inpainted. FIG. 16 illustrates an example of combining at least a portion of a shadow mask with at least one object mask corresponding to the at least one foreground object according to an exemplary embodiment. Object mask is shown in box 1601 and shadow mask is shown in box 1602. Box 1603 illustrates the combination of object mask with shadow mask.

In some cases, the furniture/object mask doesn't cover object shadows and some small portions of objects, which can interfere with the infill/inpaint quality. To remedy this, a removal mask can be used which is an inflated or dilated version of the furniture/object mask. At step 1304A, the at least one object mask corresponding to the at least one foreground object is dilated by a predetermined quantity of pixels to thereby inflate the at least one object mask. For example, the object mask/furniture mask can be dilated up to 20 pixels radially to cover a larger area around the object/objects.

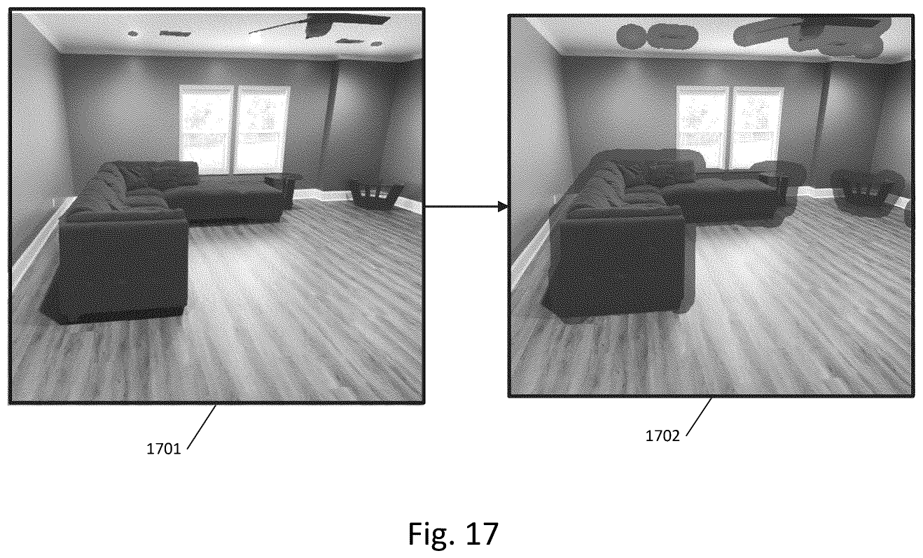

FIG. 17 illustrates an example of dilating a furniture/object mask according to an exemplary embodiment. Box 1701 illustrates a furniture mask superimposed on an RGB image. The dilated furniture mask is shown in box 1702.

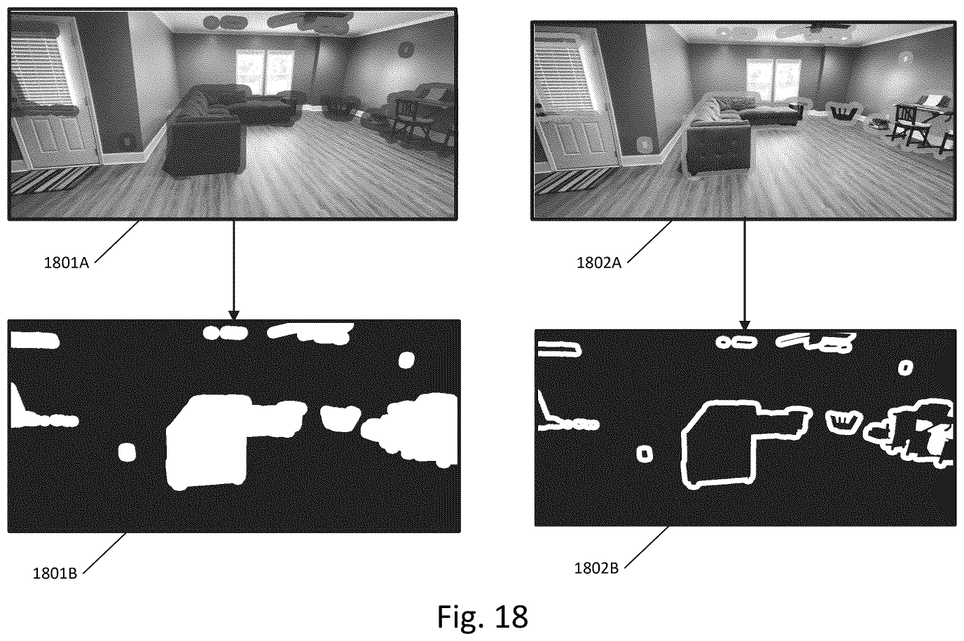

FIG. 18 illustrates the dilated furniture mask and the portion of the mask corresponding to the dilated portion according to an exemplary embodiment. Box 1801A illustrates the dilated furniture mask superimposed on an RGB image and box 1801B illustrates the dilated furniture mask itself. The inflated/dilated furniture mask covers most of the shadows and object protrusions missed by semantic/instance masks. Box 1802A illustrates just the dilated portion of furniture mask superimposed on an RGB image and Box 1802B illustrates the dilated portion of furniture mask itself, referred to as the dilation ring. Boxes 1802A-1802B can be produced by XOR the dilated furniture mask with the original furniture mask.

Uniformly inflating the instance mask can results in a lot of areas unnecessarily getting masked, including areas which can be useful as context for the texture region based inpainting algorithm. To address this, the inflation ring can be used in combination with a shadow mask. Returning to FIG. 13, at optional step 1304B at least a portion of the shadow mask is combined with the dilated object/furniture mask corresponding to the at least one foreground object produced in step 1304A. In particular, shadow cues can be used to help cover masked shadow areas and unmask non-shadow areas. A shadow mask can be part of the contextual information and can be computed in a variety of ways, including:
thresholding based on image saturation and value;
using an off-the-shelf shadow segmenter
intrinsic image decomposition followed by thresholding on the grayscale value of shading image, followed by elimination of dark reflectances using a reflectance image

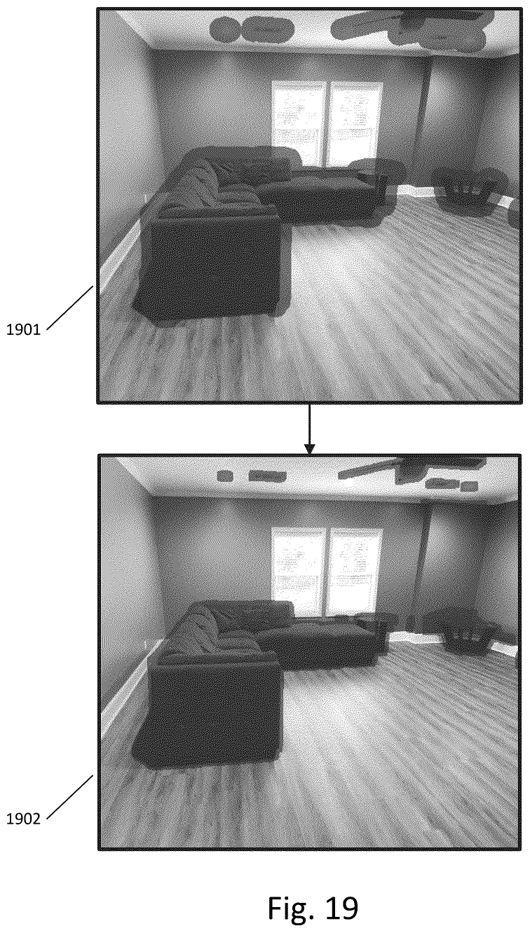

FIG. 19 illustrates an example of using shadow cues to adjust a dilated object mask according to an exemplary embodiment. Box 1901 shows a dilated furniture/object mask and box 1902 shows the dilated furniture/object mask adjusted based on the shadow mask and shadow cues.

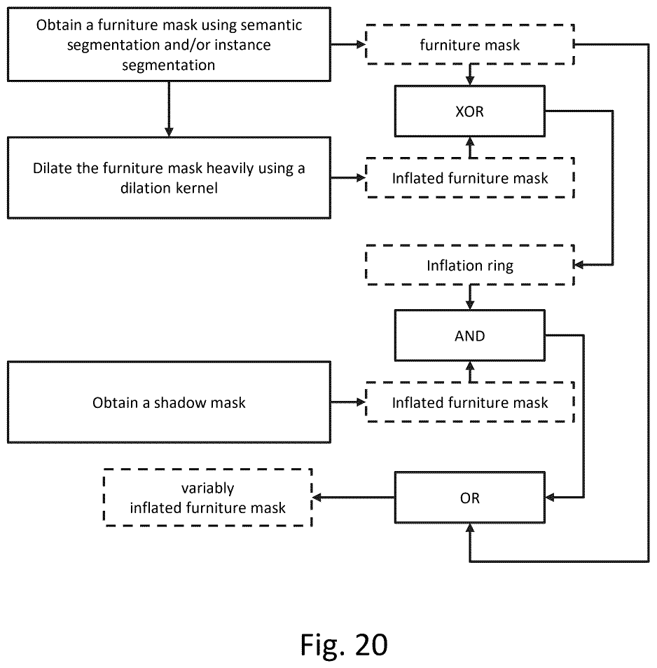

FIG. 20 illustrates a flowchart for using the shadow mask with a dilated object mask to produce a variably dilated/inflated mask according to an exemplary embodiment. When the shadow mask is used to provide context cues to the dilated object/furniture masks, the dilated mask can be adjusted by setting it equal to the furniture_mask OR'ed with the combination of the shadow mask and the dilation ring. In other words, dilated_furniture_mask=furniture_mask OR (shadow_mask AND dilation_ring).

Referring to FIG. 13, at step 1305, the at least one object mask corresponding to the at least one foreground object is modified based at least in part on the contextual information. The contextual information can include any of the information previously described.

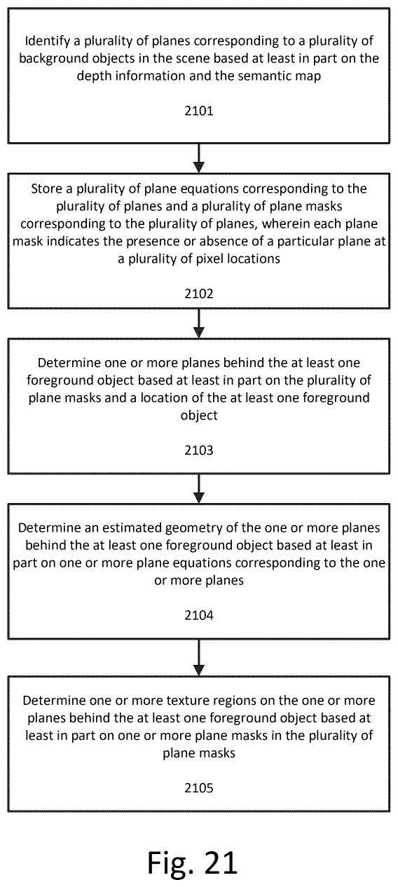

Returning to FIG. 4, at step 405 an estimated geometry of the scene behind the at least one foreground object is determined based at least in part on the contextual information. FIG. 21 illustrates a flowchart for determining an estimated geometry of the scene behind the at least one foreground object according to an exemplary embodiment.

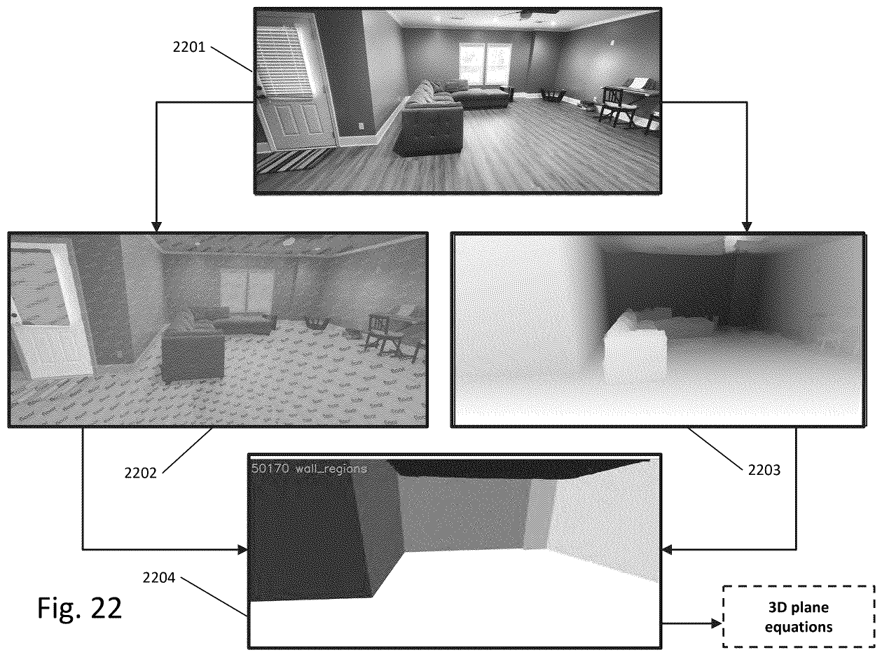

At step 2101 a plurality of planes corresponding to a plurality of background objects in the scene are identified based at least in part on the depth information and the semantic map. FIG. 22 illustrates an example of using depth information and a semantic map to identify a plurality of planes according to an exemplary embodiment. The RGB image 2201 is used to generate semantic map 2202 and depth map 2203, as discussed previously. The depth map 2203 and the semantic map 2202 are then used to determine plane masks 2204, as shown in FIG. 22. This can be performed, for example, by superimposing semantic map 2202 on depth map 2203 to determine locations of planes within the scene. The plane masks can then be used to determine 3d plane equations corresponding to the planes. The 3d plane equations can define the orientation of the planes in 3d space.

At step 2102 a plurality of plane equations corresponding to the plurality of planes and a plurality of plane masks corresponding to the plurality of planes are stored, each plane mask indicating the presence or absence of a particular plane at a plurality of pixel locations. The determination of the plane equations and the generation of the plane masks are described with respect to the previous steps. These computed values are then stored to be used when determining estimated geometry.

At step 2103 one or more planes behind the at least one foreground object are determined based at least in part on the plurality of plane masks and a location of the at least one foreground object. At step 2104 an estimated geometry of the one or more planes behind the at least one foreground object is determined based at least in part on one or more plane equations corresponding to the one or more planes.

Of course, the step of determining an estimated geometry of the scene behind the at least one foreground object based at least in part on the contextual information is not limited to planar geometry. The determination of an estimated geometry of the scene behind at least one foreground object can include determining estimated geometry that is curved, curvilinear, or arbitrary. The system can include functionality for identifying curved geometry (such as curved walls, arched ceilings, or other structures) and determining an estimate of the curvature, such as through an estimation of equations that describe the geometry or a modeling of the geometry based on continuity, or detecting and representing arbitrary geometry (e.g., with multiple parametric equations, surface meshes, depth maps, bump maps, volumetric representations, or other representations of 3D geometry).

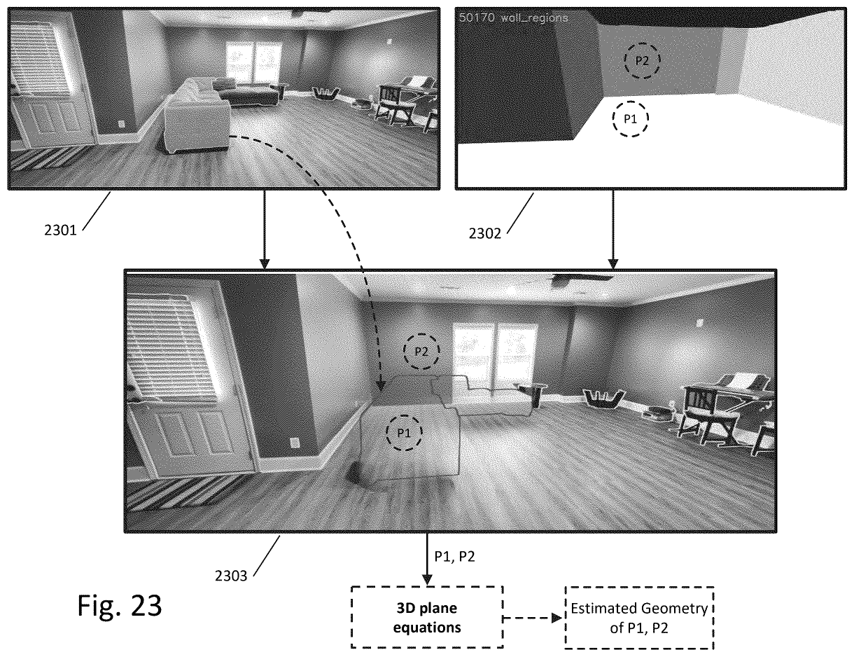

FIG. 23 illustrates an example of determining one or planes behind a foreground object based at least in part on plane masks and a location of the foreground object and determining an estimated geometry of the planes behind the foreground object based at least in part on plane equations according to an exemplary embodiment. As shown in box 2301, a user has selected a sofa for removal from the scene. The plane masks 2302 are used to determine which planes are behind this sofa, as shown in box 2303. For example, a pixel location of the removed object in the RGB image can be mapped onto the plane mask to determine which plane is at that pixel location (behind the object to be removed). Once the planes behind the sofa are determined, the 3d plane equations can be used in conjunction with the locations of pixels corresponding to the removed object to determine the estimated geometry of the planes behind the object to be removed. In this case, the system determines that planes P1 and P2 are behind the sofa and the 3d plane equations are used to determine the estimated geometry of planes P1 and P2.

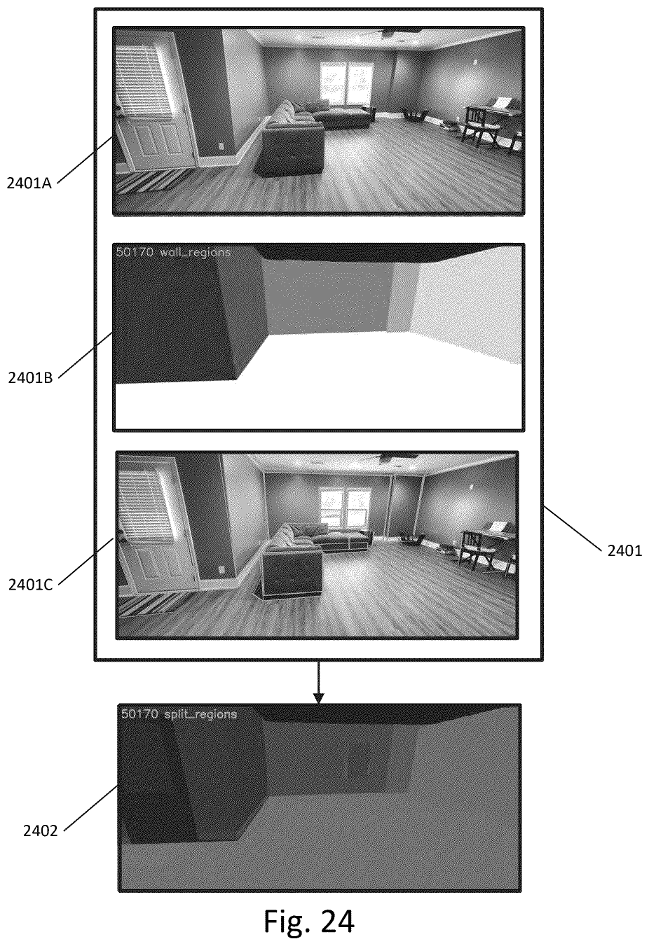

The plane masks can be used in conjunction with contextual information, such as lines in the image of the scene, to produce information about texture regions on the planes. As will be described in greater detail with respect to the inpainting process, texture regions can be used for inpainting removed portions of the image/scene. FIG. 24 illustrates an example of finding texture regions using plane masks according to an exemplary embodiment. As shown in FIG. 24, the RGB image 2401A, the plane masks 2401B, and lines 2401C and be used to split up the plane regions into texture regions, as shown in box 2402.

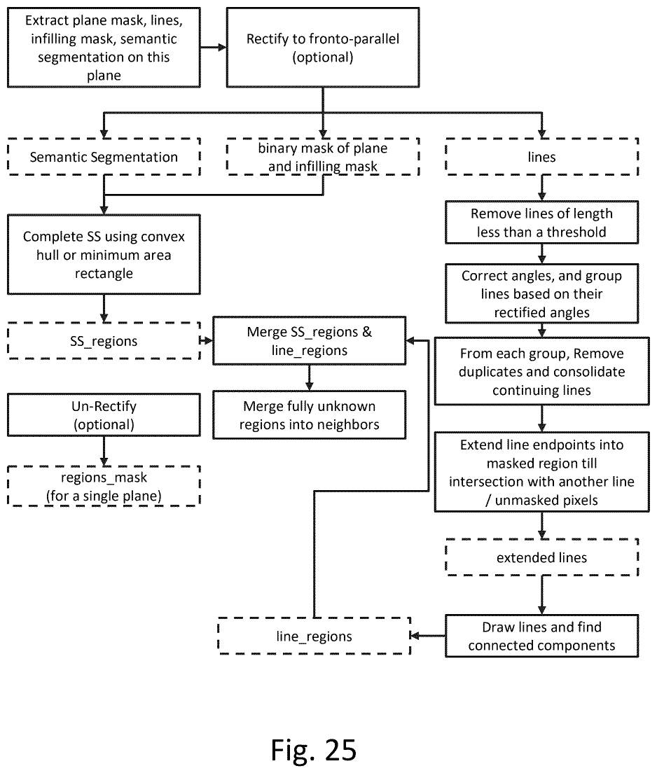

FIG. 25 illustrates a flowchart for generating a regions mask according to an exemplary embodiment. To extract texture regions, lines, and normal/plane segmentation/masks can be used to further split up the plane regions into texture regions. The process can include the below-mentioned steps for each plane, in either a normal perspective frame of reference, or in a rectified frame of reference. Rectified frames of reference are rectified via homography, as discussed further below. The steps include:
Dilating the border of the plane and add this to the removal/inpaint mask. This ensures that pixels are not lost along the border, when masks are resized/reshaped/warped.
Completing the semantic segmentation for background categories which are still objects, like window, curtain, blinds, and others by obtaining their convex hull, or minimum area rectangle, and replace the masked area with these pixels. These are referred to as SS_regions.
From the set of lines on this plane, removing very small lines, and also removing the lines which are tracing boundaries of the plane region.
Grouping the lines based on angles, and then removing lines which are duplicates/almost duplicates/in close proximity, and joining the lines with close end points and close slope. For the lines which are horizontal/vertical within a tolerance, assert/setting their angles to be exact 0 or 90 degrees.
For each line, extending both its endpoints in the masked region till it intersects with another line, or with unmasked pixels.
Drawing these lines in black (0) on a white canvas (1), dilating them, and then obtaining connected components.
Overwriting the areas with non-zero SS_regions on the top of these regions, to give higher priority to regions carved by using semantic segmentation information. This is to ensure that windows/doors/curtains, which often have repeatable texture with very few textons (i.e., fundamental visual structures) as basis of their texture, are not cut up.
There could be some regions which do not have a lot of source (unmasked) pixels. These regions won't be sufficiently informative, because they do not have any source pixels to query about the texture of masked pixels. The regions are merged to the neighbors with largest common edge, which have appreciable source pixels.

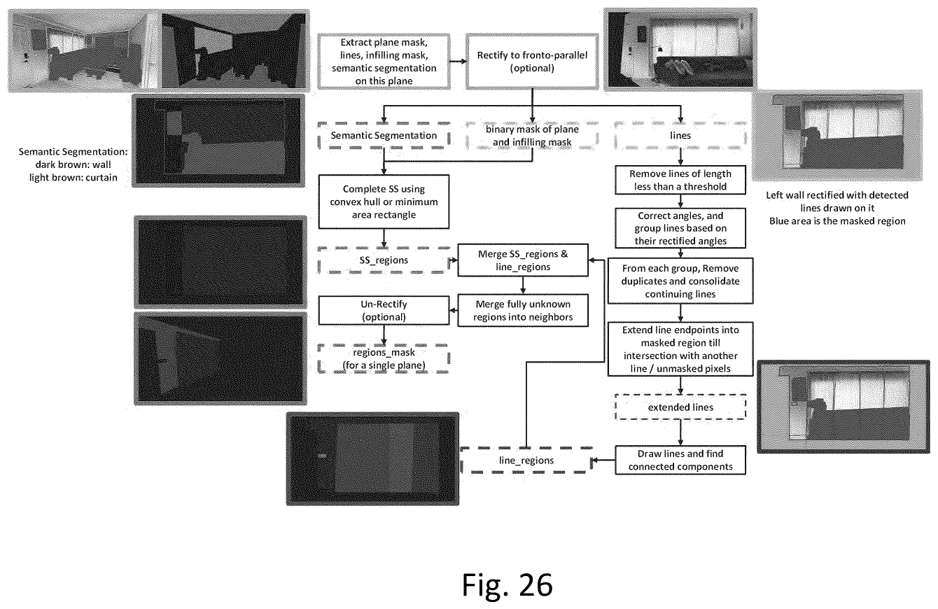

FIG. 26 illustrates another flowchart for generating a regions mask according to an exemplary embodiment. The flowchart of FIG. 26 is similar to FIG. 25 but includes examples of outputs at different steps, including plane masks, regions masks, semantic segmentation, lines, extended lines, fronto-parallel rectification, and semantic segmentation regions. As shown in the figure, solid lined boxes correspond to algorithm/processes and dashed line boxes corresponding to data/images.

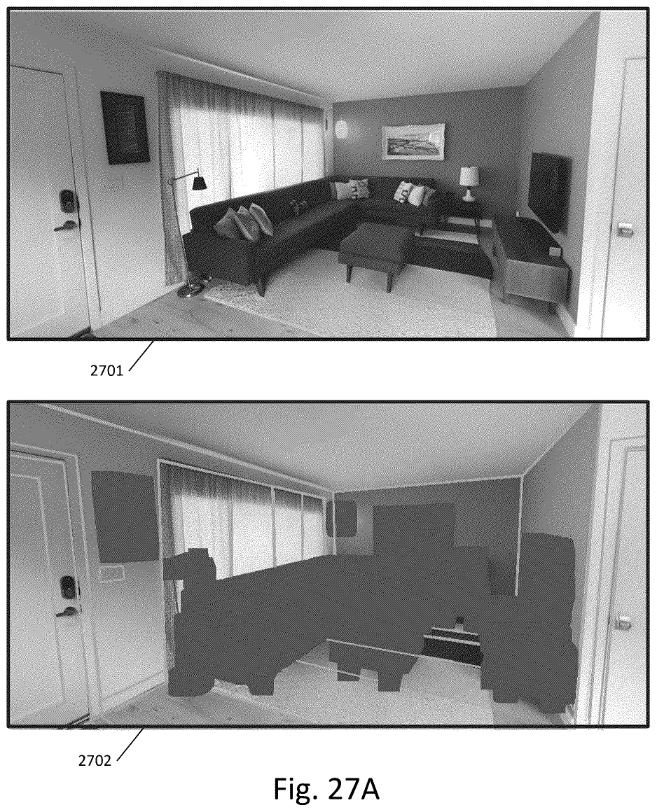

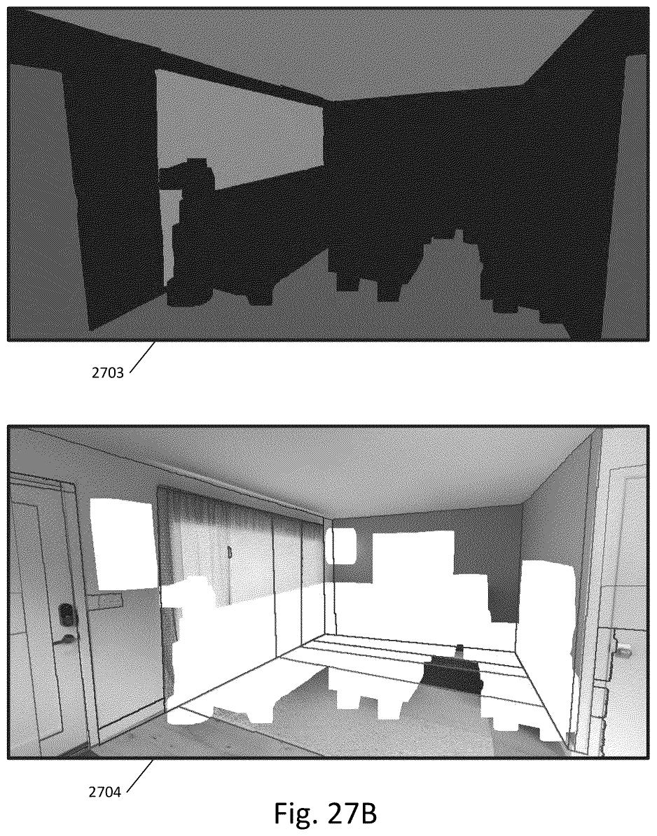

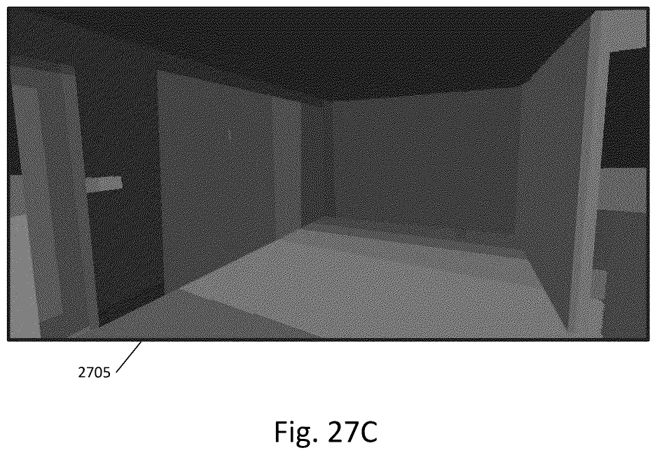

FIGS. 27A-27C illustrate examples of the input and output of the segmentation and geometry determination processes described herein according to an exemplary embodiment. Referring to FIG. 27A, box 2701 illustrates an input RGB image and box 2702 illustrates a masked image with lines. Referring to FIG. 27B, box 2703 illustrates a masked image with semantic segmentation and box 2704 illustrates texture regions on planes and marked by lines. Referring to FIG. 27C, box 2705 illustrates texture regions shown by a different color for each region. The regions can be used when determining where to sample or incorporate particular textures when inpainting.

Returning to FIG. 4, at step 406 pixels corresponding to the removal mask are inpainted with a replacement texture omitting the at least one foreground object based at least in part on the estimated geometry of the scene behind the at least one foreground object. This step results in a more accurately representation of the geometry and semantics of the scene after foreground object removal.

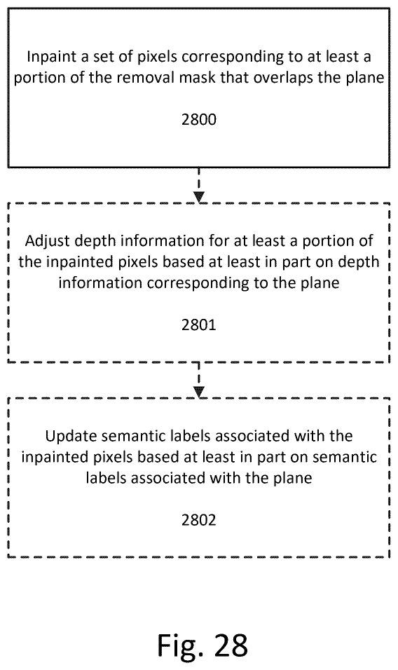

FIG. 28 illustrates a flowchart for inpainting pixels corresponding to the removal mask with a replacement texture omitting the at least one foreground object based at least in part on the estimated geometry of the scene behind the at least one foreground object according to an exemplary embodiment. The steps shown in FIG. 28 can be performed for each plane that is to be inpainted.

At step 2801 a set of pixels corresponding to at least a portion of the removal mask that overlaps the plane are inpainted. The specific techniques for inpainting are described further below. Optionally, at step 2801 the depth information for at least a portion of the inpainted pixels is adjusted based at least in part on depth information corresponding to the plane being inpainted. Additionally, at optional step 2802 semantic labels associated with the inpainted pixels are updated based at least in part on semantic labels associated with the plane.

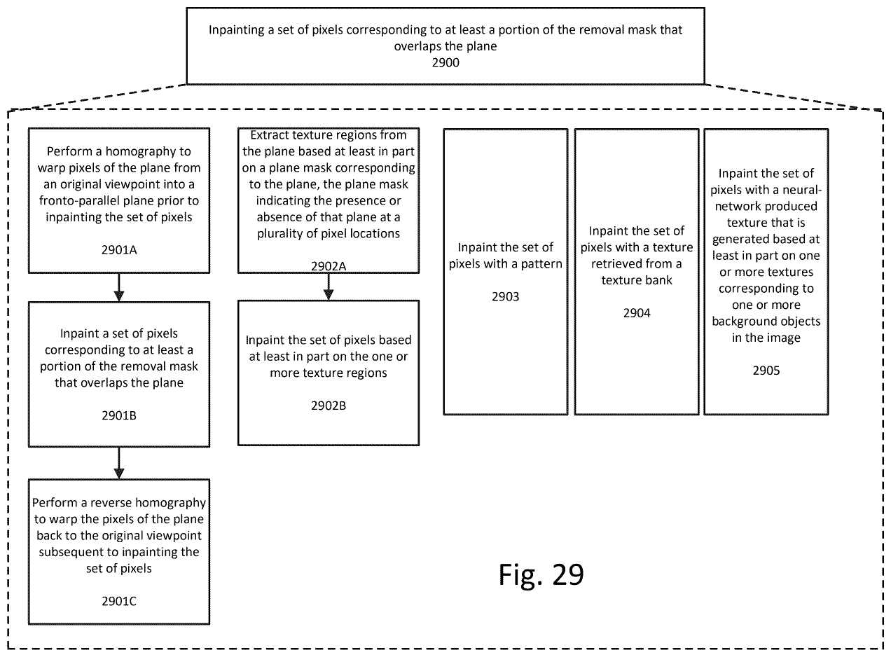

FIG. 29 illustrates a flowchart for inpainting a set of pixels corresponding to at least a portion of the removal mask that overlaps the plane according to an exemplary embodiment. As shown in FIG. 29, this step can be performed in multiple different and/or overlapping ways, including steps 2901A-2901C, steps 2902A-2902B, step 2903, step 2904, and/or 2905. These flows and steps can be combined in various different ways. For example, the homography translations of steps 2901A-2901C can be performed for every type of inpainting.

At step 2901A, a homography is performed to warp pixels of the plane from an original viewpoint into a fronto-parallel plane prior to inpainting the set of pixels. At step 2901B, a set of pixels is inpainted corresponding to at least a portion of the removal mask that overlaps the plane. At step 2901C, a reverse homography is performed to warp the pixels of the plane back to the original viewpoint subsequent to inpainting the set of pixels.

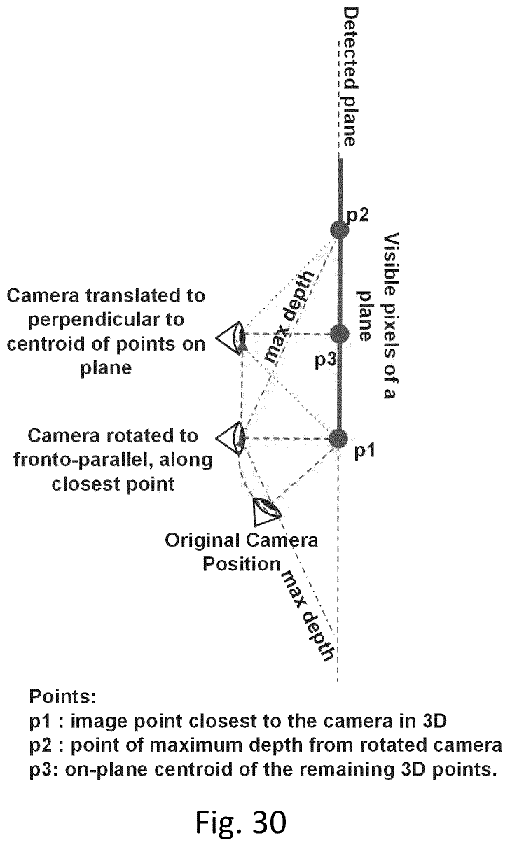

FIG. 30 illustrates a diagram showing how homography mappings are obtained.

As input, the process can take (one or more aligned) images, object instances, semantic segmentation, plane equations, plane masks, (optional) texture regions, and (optional) gravity. For each plane, the 3D plane equation, plane masks, and camera intrinsics are used to obtain a homography in the following steps:
Unproject the points belonging to the plane mask to get a 3D point cloud.
Rotate the camera in 3D so that the distance of camera from nearest point (p1 in figure) is same.
Cut a cone of max depth and remove the points lying beyond that (points beyond p2 in figure). We do not care about very far off points.
Translate the camera parallel to the plane, so that it's directly above the centroid of the remaining points (p3 in figure).
If the plane is a wall, rotate the camera along its axis, so that gravity vector is +y direction in camera frame.
If the plane is a floor/ceiling, rotate the camera along its axis, so that-z direction in original camera frame is +y in new camera frame.

Multiple homographies can also be calculated with multiple max-depth values. The output of the above process is the per-plane homographies.

Homography can be used infill per plane. In this case, the input can include (one or more aligned) image, object instances, semantic segmentation, plane equations, plane masks, (optional) texture regions, and (optional) gravity. For each plane, the process can include using the 3d plane equation, plane masks, and camera intrinsics to obtain a homography in the following steps:
First, all the images and masks can be optionally resized to a smaller resolution, to allow faster computing.
The homography is utilized to infill texture in planar regions, one plane at a time.
For each plane, it can be rectified using homography, infilled/inpainted, and then unrectified, to replace the masked pixels with the inpainted pixels.
This unrectified plane can then be upscaled and the plane mask can be used to update the masked pixels with the texture, in the texture buffer.

An ‘image synthesis buffer’ can be maintained that, after processing each plane, changes the value of all pixel locations which were updated in texture buffer as True. This mask helps to avoid overwriting any pixel in texture buffer.

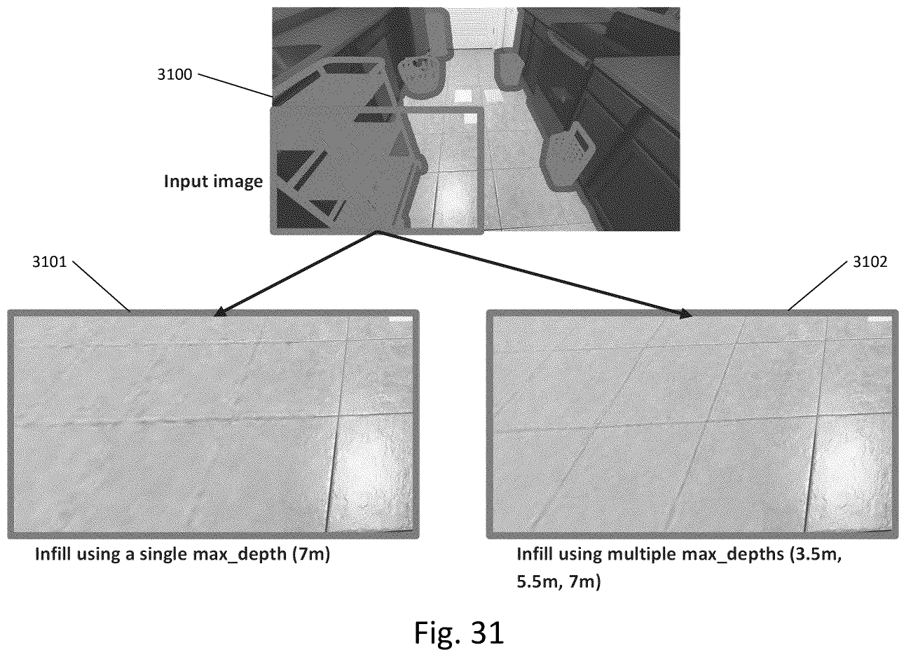

FIG. 31 illustrates an example of using multiple homographies to infill large planes according to an exemplary embodiment. As input, this process can take one or more aligned images, object instances, semantic segmentation, plane equations, plane masks, plane homographies, and (optional) texture regions.

Sometimes, the orientation of the camera is such that it is close to a very large plane. Using a single large max_depth (as shown in FIG. 30) in this case can result in losing the resolution of nearby pixels, to accommodate far off pixels during rectification.

To address this issue, the following process is used:
Perform a first rectification using a smaller max_depth, and infill the texture.
Perform a second rectification using a larger max_depth, but only infill the texture in the remaining region, which was cropped by the previous depth value.

The above process can be repeated as necessary with different max depths in order to perform more than two rectifications, as required. FIG. 31 shows the results of using multiple homographies to infill planes. A portion of image 3100 shown in a box provides the input image to the homography and infill process. Box 3101 shows the results of the infill/inpainting process using a single homography translation with a max_depth of 7 m. By contrast, box 3102 shows the results of the infill/inpainting process using multiple homographies with max_depths of 3.5 m, 5.5 m, and 7 m.

As shown in the figure, a single max-depth of 7 m has much less detail of the tile edges, than the multi-homography setting. A comparison with single max-depth of 3.5 m is not shown because most scenes/rooms are of the size ~4-5 m or more, and distances less than ~7 m would result in cropping of large portions of the available scene.

As discussed previously, the estimated geometry of the scene can include regions that are not planar, such as curved walls or ceilings, architectural millwork, or similar features. In this case, rather than performing homographies, the step of inpainting pixels corresponding to the removal mask with a replacement texture omitting the at least one foreground object based at least in part on the estimated geometry of the scene behind the at least one foreground object can include:
performing a transformation to warp pixels corresponding to the estimated geometry from an original viewpoint into a frontal viewpoint prior to inpainting the set of pixels; and
performing a reverse transformation to warp the pixels of the estimated geometry back to the original viewpoint subsequent to inpainting the set of pixels.

A frontal viewpoint can be a viewpoint in which the camera is directly facing a center or centroid of the pixels to be inpainted (i.e., in the case of curved surfaces) or directly facing and parallel to a plane tangent to the surface to be inpainted at the inpainting location. In the scenario where a three dimensional model of the scene is utilized, the transformation and reverse transformation can correspond to a movement of a camera in three-dimensional space to achieve the frontal viewpoint.

Referring back to FIG. 29, at step 2902A, one or more texture regions are extracted from the plane based at least in part on a plane mask corresponding to the plane, the plane mask indicating the presence or absence of that plane at a plurality of pixel locations. At step 2902B the set of pixels are inpainted based at least in part on the one or more texture regions.

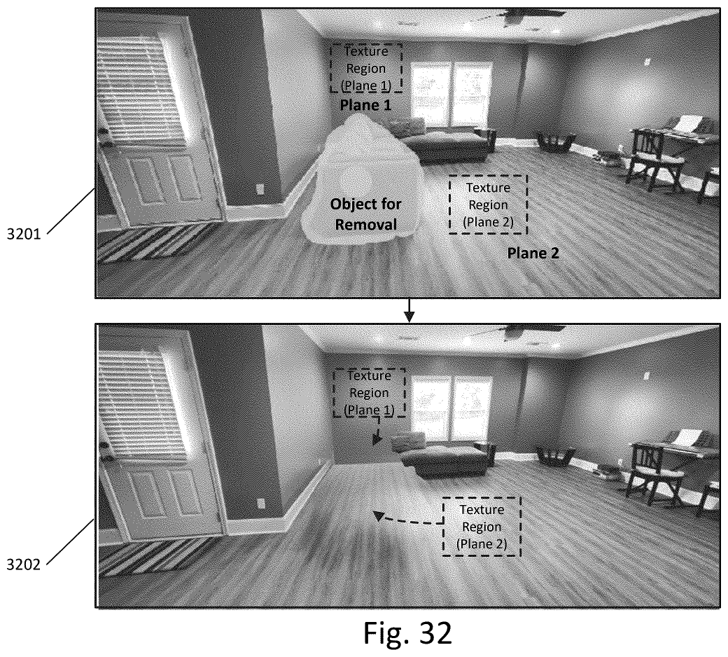

FIG. 32 illustrates an example of inpainting by extracting texture regions per plane and inpainting the background/layout planes based on extracted texture regions according to an exemplary embodiment.

As shown in box 3201, an object in the scene is selected for removal. Using the plane masks previously described and the locations of the pixels in the object to be removed, the system can determine that plane 1 and plane 2 are at least two of the planes that are behind this object. Optionally, the texture regions can further indicate different texture regions on each plane and this information can be used to determine both the planes that are occluded by the object and the specific texture regions that are occluded by the object.

Having identified the relevant occluded planes (and optionally the relevant occluded texture regions), textures are extracted from each of the planes (and optionally from each of the texture regions) for use in the infill/inpainting process. The textures can be extracted from portions of the plane (and optionally the texture region) that are not occluded (as indicated by the contextual information).

The extracted texture regions are then used to inpaint the portions of planes behind the removed object (i.e., the portions of the planes occluded by the object), as shown in box 3202. This inpainting can use a variety of different techniques which utilize the texture regions, including neural network based inpainting techniques (as described below) and/or inpainting techniques which use the texture regions for sampling of pixels to use for inpainting. For deep neural network based approaches, these texture regions can be used to extract edges, and then pass the edge-mask as additional input to the inpainting network while training, so that it can be used as guidance during inference. For non-neural network based inpainting approaches, these texture regions can act as sampling regions so that every pixel is infilled with a pixel from the same sampling region. Additionally, during the refinement process, discussed below, histogram losses within these regions can be used instead of within “plane-regions.”

Returning to FIG. 29, at step 2903 the set of pixels are inpainted with a pattern, such as a grid. The input to this process can be one or more aligned images, object instances, semantic segmentation, plane equations, plane masks, plane homographies, and, optionally, texture regions. The output of this process can be an image with the remove furniture/foreground objects replaced with checkerboard/grid patterns.

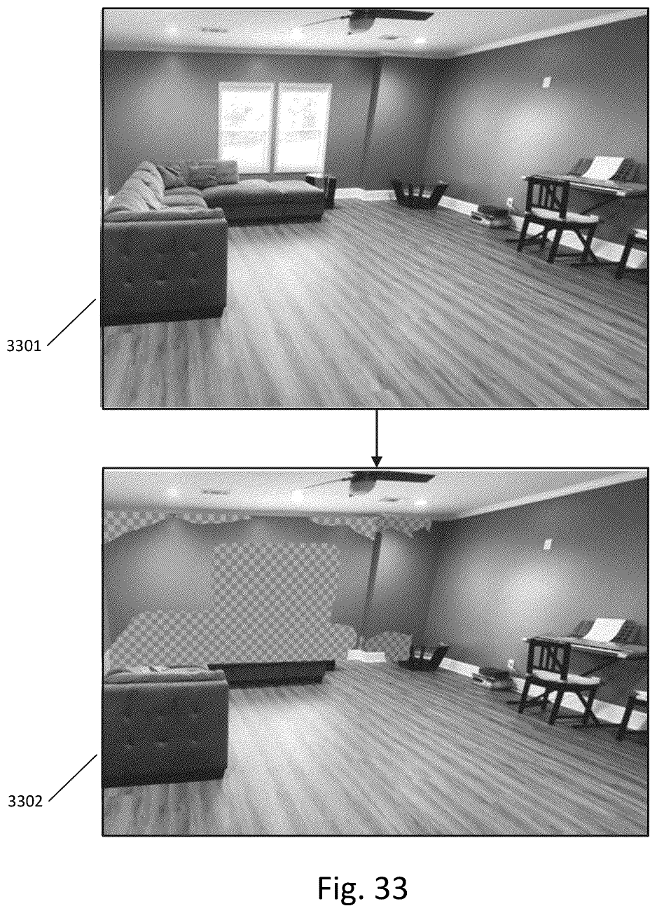

FIG. 33 illustrates an example of inpainting with a grid pattern according to an exemplary embodiment. As shown in FIG. 33, all foreground objects occluding the back wall of the scene shown in box 3301 are replaced with a grid pattern, as shown in box 3302.

To replace the texture with grids, a median of all the pixel values of background categories can be determined and used to create a fronto parallel checkerboard pattern, with alternating colors, one being the original color, and the other being a brightened version of it. The checkerboard squares can be various different sizes. For example, the checkerboard squares can be approximately 10 cm in size. In order to generate squares of a particular size, the length/width of each square can be determined in pixels using the 3D plane equation, homography, and camera intrinsics/information.

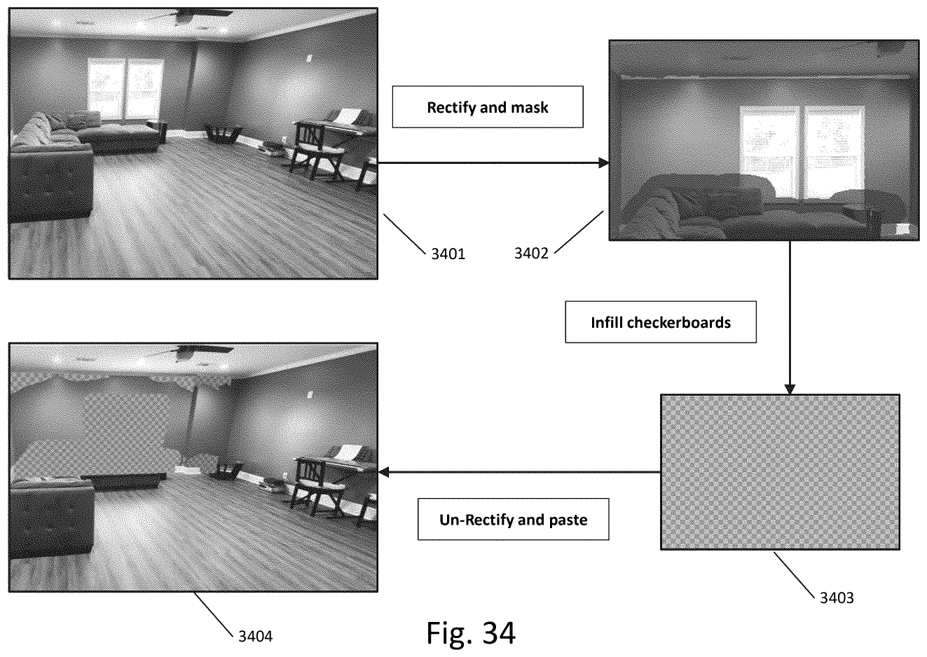

FIG. 34 illustrates an example of inpainting with a grid pattern and homography rectification/mappings according to an exemplary embodiment. The initial image of the scene 3401 is rectified (i.e., homography mappings are applied to obtain a fronto-parallel view) and masked, as shown in box 3402. A checkerboard infill pattern 3403 is then applied to the masked regions and the image is un-rectified (reverse homography mappings are applied to obtain the original view), resulting in the image shown in box 3404.

Returning to FIG. 29, at step 2904 the set of pixels are inpainted with a texture retrieved from a texture bank. The texture bank can be an electronic catalog of textures corresponding to different surfaces, materials, and/or semantic labels. In some cases, there may not be sufficient pixels of a similar texture remaining in a scene to perform an inpainting of a removed portion of the scene based on the similar texture. For example, a removal of an object such as a large bookshelf may result in removal of nearly an entire plane of the scene, such as the wall behind the bookshelf. In this case, the system can look up a similar material/texture to the texture to be inpainted in a material/texture bank or electronic catalog that stores materials/textures. A similar material/texture can be retrieved based on the visual appearance of a portion of remaining portions of the texture, a semantic label assigned to the geometric structure, plane, or texture (e.g., hardwood floor), and/or other contextual information relating to the plane, geometric structure, or texture.

At step 2905 the set of pixels are inpainted with a neural-network produced texture that is generated based at least in part on one or more textures corresponding to one or more background objects in the image. The textures can be, for example, the textures extracted in step 2902A.

This step can take as input the one or more aligned images, object instances, semantic segmentation, plane equations, plane masks, plane homographies, and (optional) texture regions. To inpaint the texture using a neural network, a union is taken of both the rectified inpaint mask and a rectified unknown mask (pixels which are unknown, but come into image frame due to warping). This can be done because a value cannot be assigned to the pixels and neural network expects a rectangular image as input. As output, this step produces a texture image with removed furniture/foreground objects area inpainted with a background texture that is generated using a neural network.

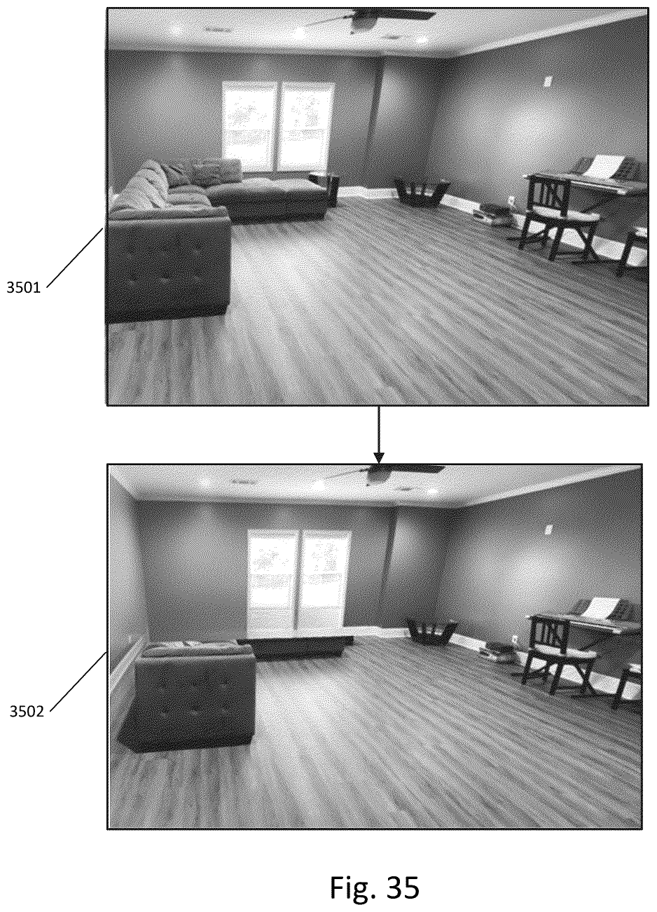

FIG. 35 illustrates an example of inpainting with a neural network according to an exemplary embodiment. As shown in FIG. 35, all foreground objects occluding the back wall of the scene shown in box 3501 are replaced with inpainting generated using a neural network and (optionally) the previously extracted textures per plane and/or texture region, as shown in box 3502.

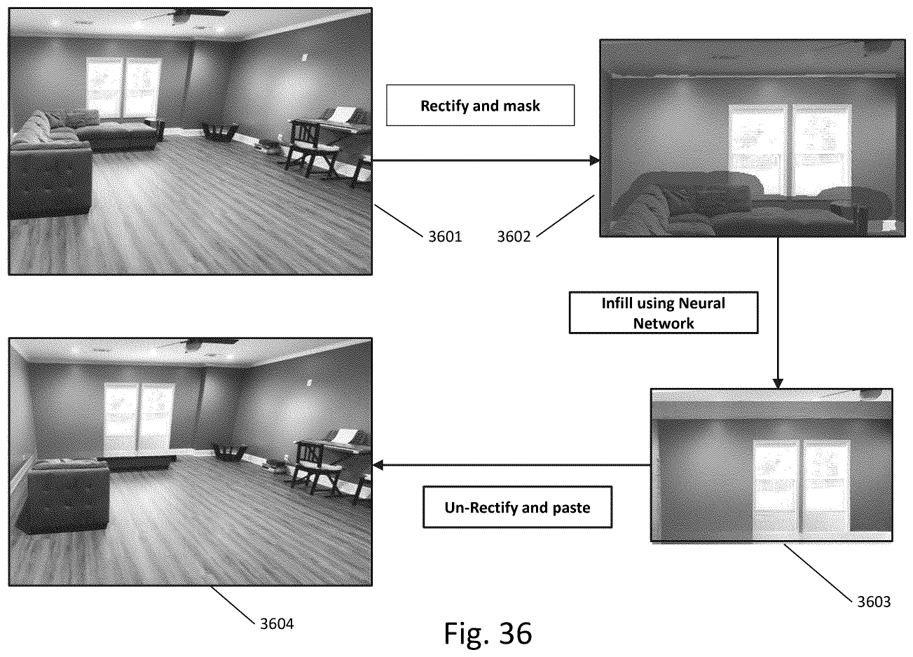

FIG. 36 illustrates an example of inpainting with a neural network and homography rectification/mappings according to an exemplary embodiment. The initial image of the scene 3601 is rectified (i.e., homography mappings are applied to obtain a fronto-parallel view) and masked, as shown in box 3602. The masked regions are then infilled using a neural network, as shown in 3603, and the image is un-rectified (reverse homography mappings are applied to obtain the original view), resulting in the image shown in box 3604.

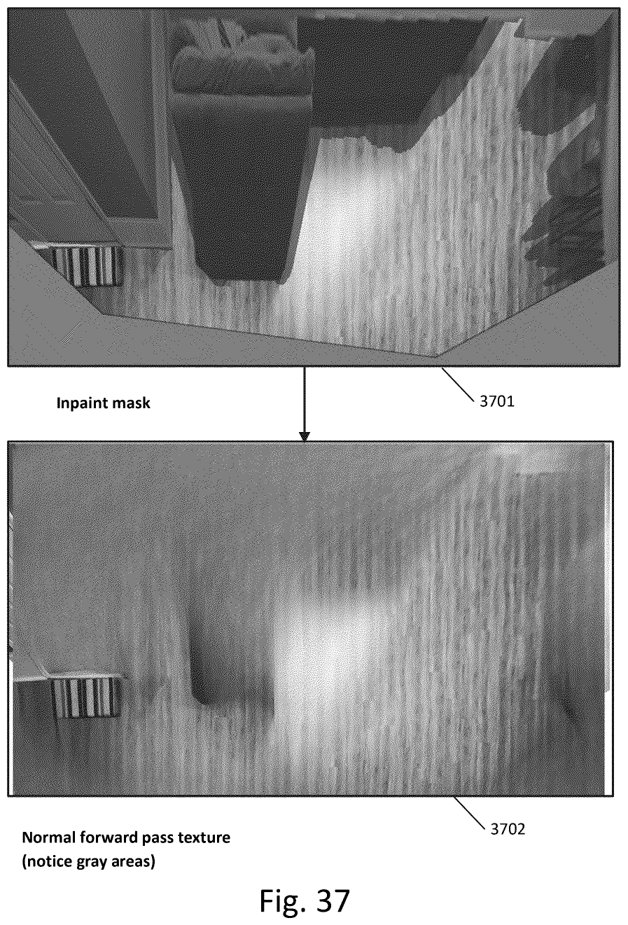

It has been observed that when a neural network is used for inpainting, the infilled texture has gray artifacts when the mask to be inpainted is too wide. FIG. 37 illustrates an example of neural network based inpainting and gray artifacts. As shown in the figure, the masked region of scene shown in box 3701 is inpainted with a neural network to generate the result shown in box 3702. The resulting texture includes gray areas that are undesirable and inaccurate reconstructions of the underlying/occluded textures.

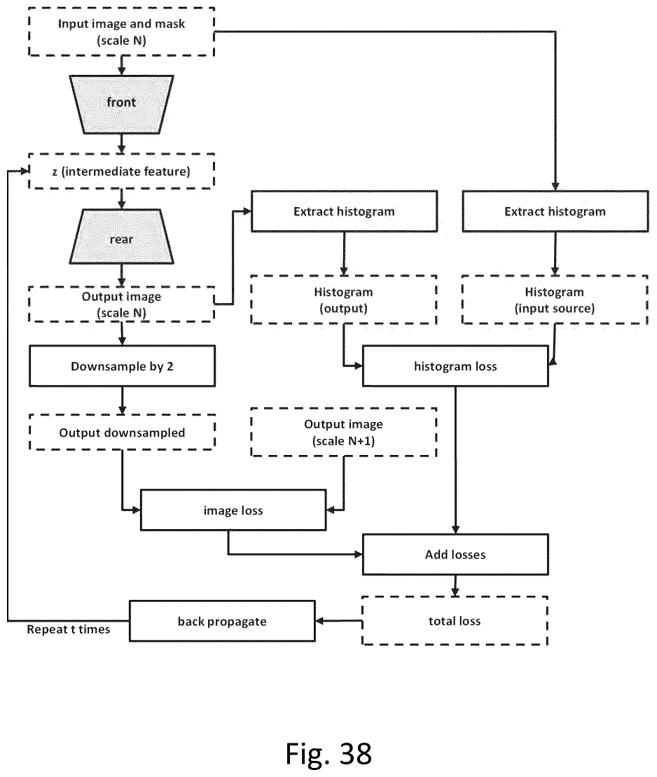

In order to address this issue, the pre-trained inpainting neural network can utilize texture/feature refinement software. FIG. 38 illustrates the operation of the neural network feature refinement software according to an exemplary embodiment.

As shown in FIG. 38, the neural network is split into 2 parts, nn_front and nn_rear, and the weights for each are frozen. The feature refinement software produces intermediate features, z=nn_front(Image). Let the predicted image be im_pred=nn_rear(z). Then, these features are updated for t iterations using a gradient descent based optimizer, with a sum of one or more of the following losses for one or more iterations:

multi-scale loss: predictions are made at multiple scales. For a scale N, we consider image of size N/2 to be at scale N+1. The feature refinement software downsamples (differentiably) the output scale N, and then produces an image to image loss with scale N+1 image. Image to image loss could be L1 loss, L2 loss, perceptual loss, etc.

histogram loss: The feature refinement software calculates histogram of unmasked pixels, and the histogram of the predicted image. Distance between the two histograms is called histogram loss.

As shown in FIG. 38 and described above, the feature refinement software updates the image encoded as feature z, resulting in feature refinement for texture refinement. This direct refinement of feature with a combination of multi-scale loss and histogram loss is a novel technique for inpainting of textures. The combination of the two losses is important, as it creates a better texture than using either of the two losses alone. This texture refinement with custom losses can also be used for consistency in inpainting from multiple views, inpainting shading and reflectance, etc.

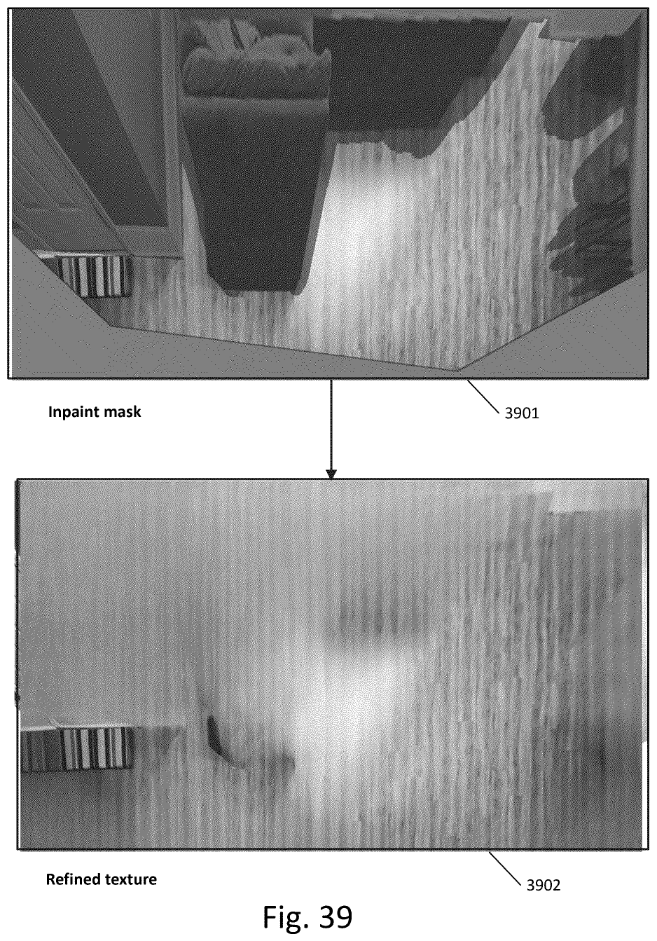

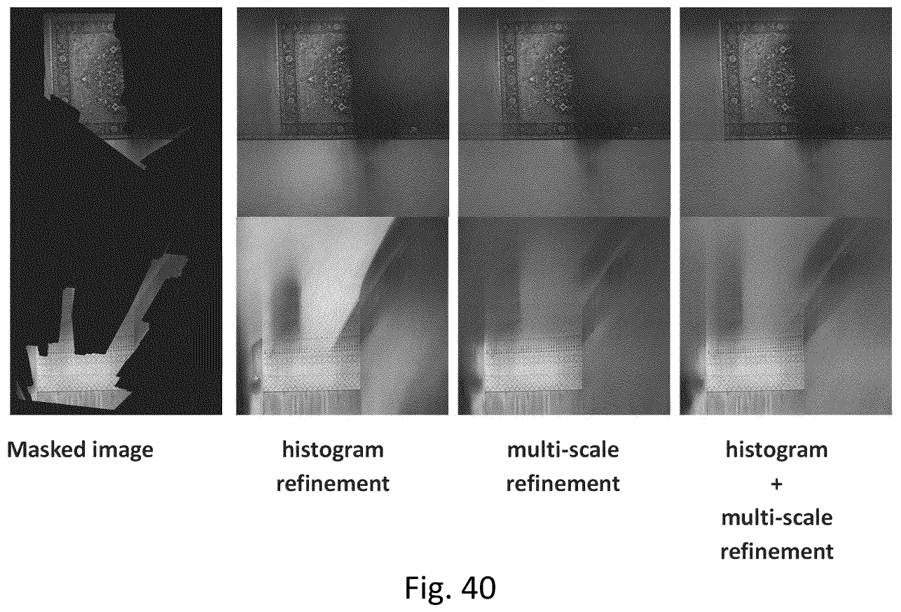

FIG. 39 illustrates an example of neural network based inpainting using the disclosed feature refinement software according to an exemplary embodiment. When inpainting is applied to the mask shown in box 3901, the output is the refined texture shown in box 3902. As shown in FIG. 39, the gray artifacts that are present in FIG. 37 are no longer present in the inpainted image. The combination of histogram and multi-scale refinement produces better results than either of these method alone. FIG. 40 illustrates an example of inpainting a masked image with histogram refinement, multi-scale refinement, and histogram plus multi-scale refinement according to an exemplary embodiment.

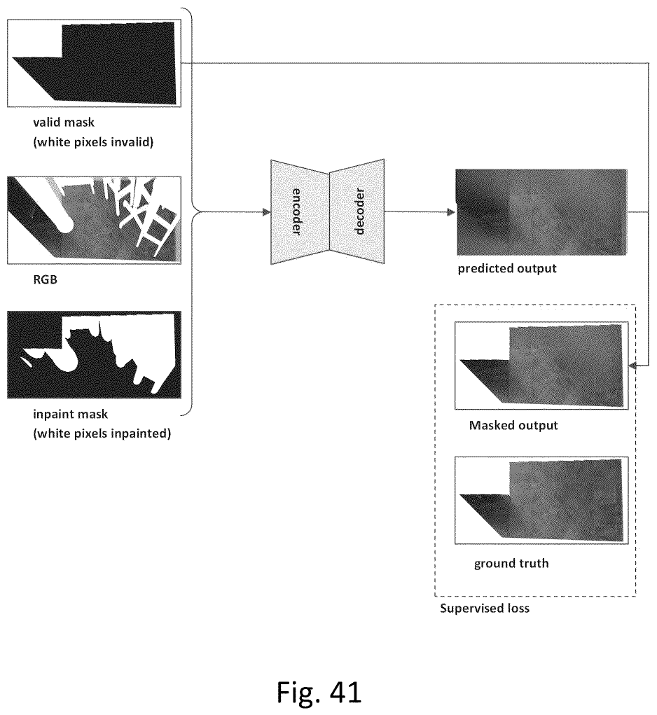

FIG. 41 illustrates an example of the operation of the inpainting neural network according to an exemplary embodiment. The neural network utilized by the present system can be trained from scratch. The input to the training process can include a database of millions of indoor scenes, each scene comprising of all the inputs/outputs described with respect to the input preprocessor. Inputs can also include pairs of furnished and empty room scenes. The present system performs offline supervised refinement of all the weights of a neural network over millions of images. The inpainting neural network of the present system offers many advantages over external networks. In particular:
Existing inpainting networks require square image as input. However, a warped plane will often not look rectangular. Existing techniques do not have an explicit constraint with formulation to encourage strict, 0 pixel leakage. The disclosed network is trained to respect an inpainting mask strictly by passing a valid mask, and along with the inpaint mask, replacing invalid mask pixels with a color or random noise. And in the predicted image, before applying any losses, the present system masks out the areas corresponding to these masks. This encourages the network to completely ignore the masked area while inpainting.
The disclosed neural network can be utilized for an end to end image translation network which takes as input a furnished room, and then outputs its empty version. Synthetic data can be used for training the network in this case.

The above described methods can be supplemented with a number of additional and optional techniques to improve inpainting results and expand the use cases for inpainting to a variety of different scenarios. These additional techniques are described in greater detail below.

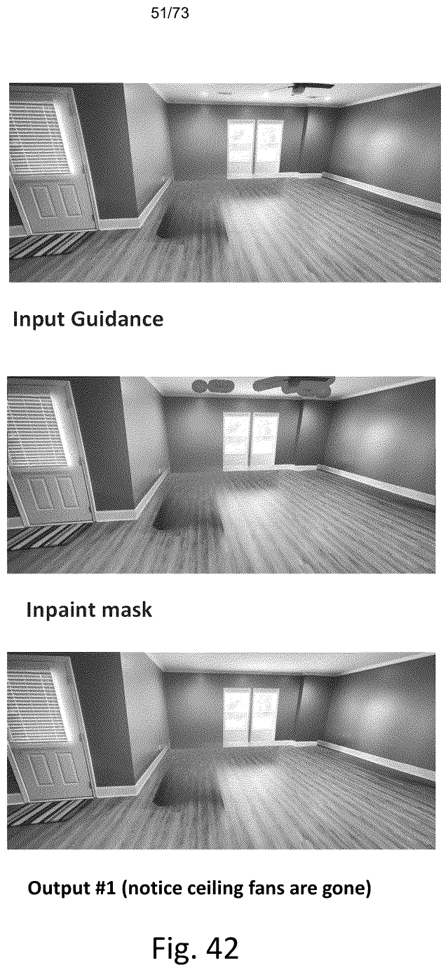

FIG. 42 illustrates an example of guided inpainting of non-planar areas according to an exemplary embodiment. Input can include a plane-wise inpainted image(s), infill mask, and plane boundaries. The process includes replacing all the furniture areas of planar regions with the inpainted image and infilling the remaining furniture area of non-planar regions with this image as the source. The output is a completely infilled image with smoother layout seams.

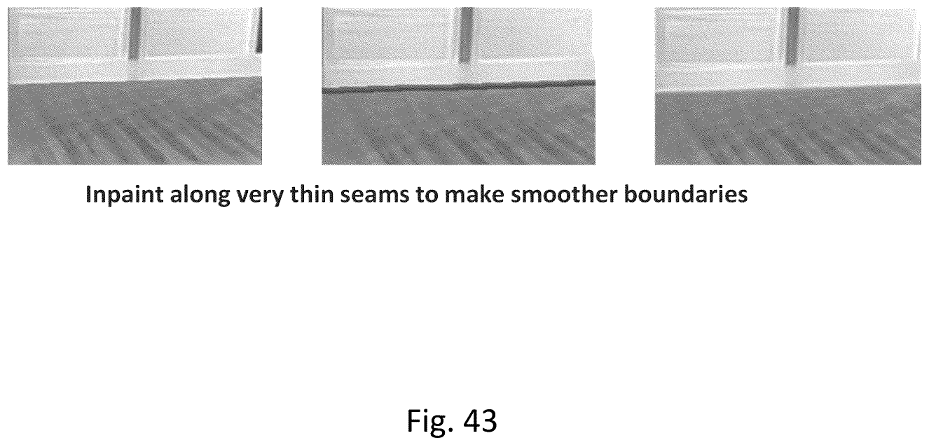

FIG. 43 illustrates an example of boundary sharpness inpainting according to an exemplary embodiment. The input to the process includes an inpainted image and plane masks. If the plane boundary masks create a jagged border, this gets replicated in the same way into the texture, created a jagged seam between wall-floor or wall-wall. To solve this issue, plane masks are used to identify boundaries falling into the inpainted region. The boundary is dilated very slightly, to create an inpaint mask which is a thin strip along the seam (shown as highlighted area in FIG. 43). This area is inpainted using a texture inpainting algorithm, to get a seamless transition between the two planes. The output of this process is a completely infilled image with smoother layout seams.

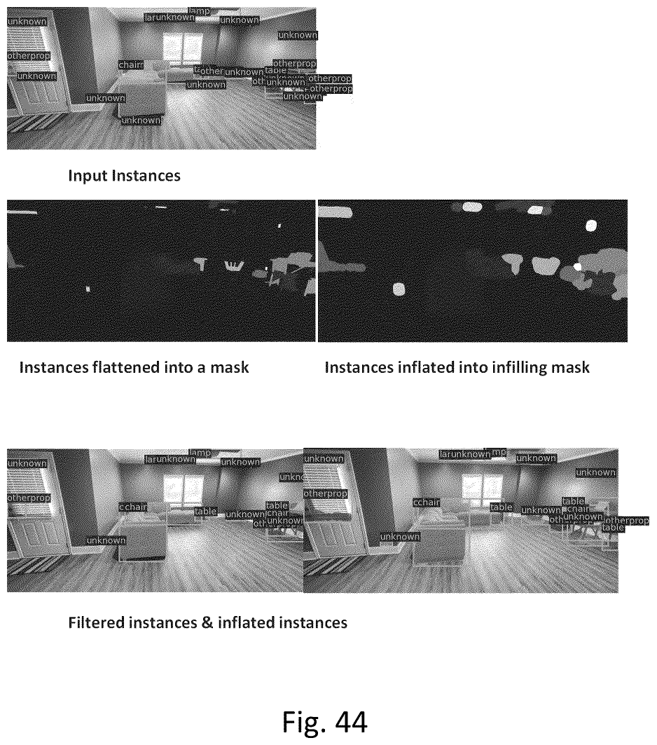

FIG. 44 illustrates an example of filtered and inflated instances for inpainting according to an exemplary embodiment. This takes as input the neural network instance segmentation predictions and transforms the raw predictions into fewer intuitive groupings for a more natural erasing experience. The process filters the instances to merge very small unknown classes into furniture classes and includes the following steps:
Combine small instances of the same class into a larger neighboring segmentation.
Combine small instances of unknown/other class into a larger neighboring segmentation.
Combine small instances to another class based on proximity weighted by overlap location. For example, combine a vase having a bottom that largely overlaps with a table.
Infill small holes in a segmentation.
Ensure instance masks are mutually exclusive using a priority loss.
Remove the instances in the areas where a wall wasn't detected, to avoid exposing inconsistent geometry to user while decorating.
Inflate the instances into infill mask, using watershed algorithm, with original instances as markers. Inflating the instances is necessary to ensure smooth transition between real and inpainted textures.

The output of this process is paired instances-inflated instances.

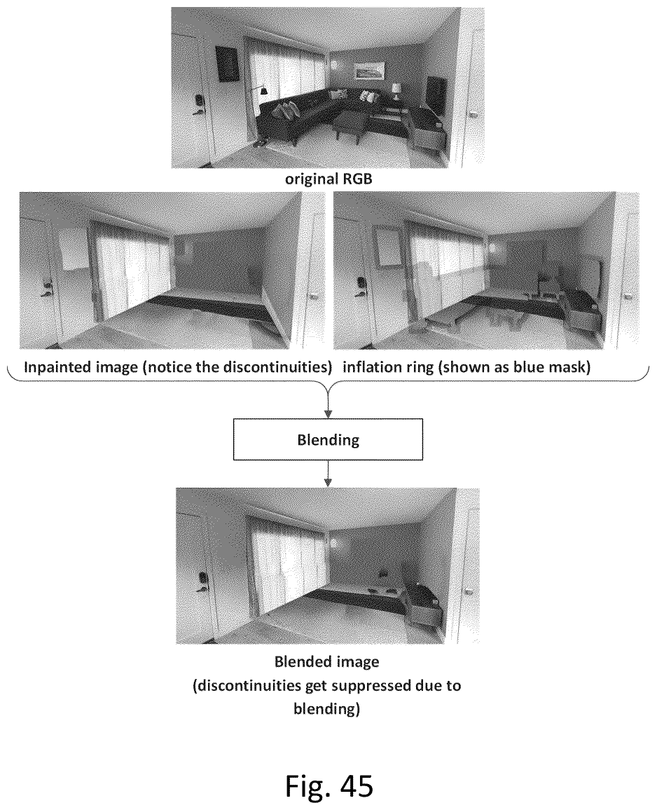

FIG. 45 illustrates an example of blending the inpainted texture according to an exemplary embodiment. The input to this process is the original RGB image, the inpainted RGB image, and the inflation/dilation ring.

The inpainted texture can sometimes have discontinuity along the mask boundaries. To solve this problem, blending of the inpainted RGB texture inside the inflation ring and the original RGB texture outside the inflation ring can be performed.

The process includes alpha blending between the original RGB and the inpainted RGB in the inflation ring area. The inpainting neural network specialized to inpaint narrow masks can also be used to inpaint the region marked by inflation ring. The output of this process is an inpainted RGB image blended with source pixels.

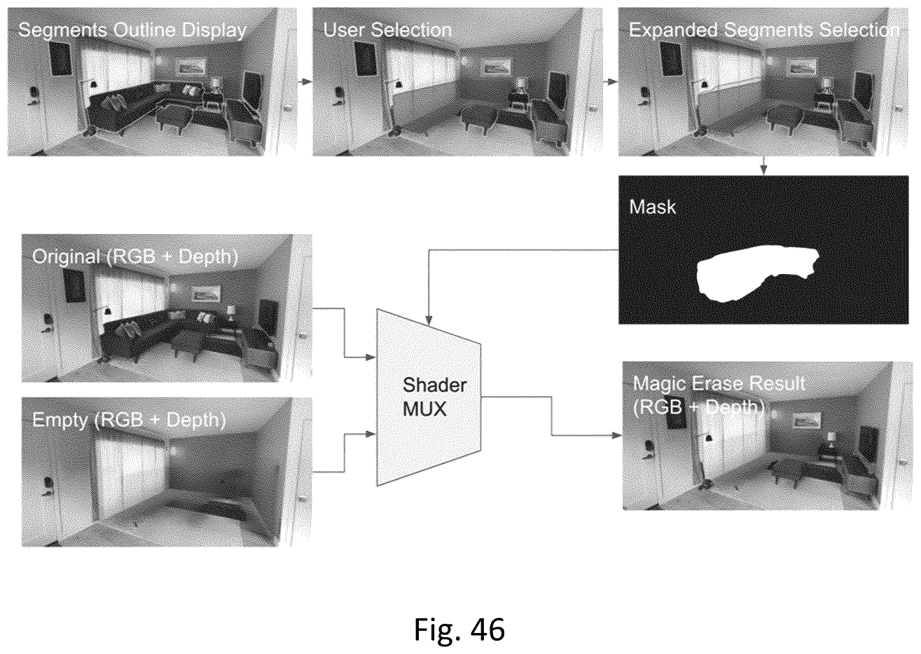

FIG. 46 illustrates an example of a furniture eraser feature according to an exemplary embodiment. The disclosed techniques can be implemented as a furniture eraser feature. The current and preferred approach has the benefits of being non-destructive, pre-computed, and real-time.

As part of this process, two variants of a required set of assets necessary to room-decoration are produced and maintained. These include furnished-room assets and empty-room assets. These are described below.

Furnished-room assets (“Original” in FIG. 46):
Original image (e.g. stitched panorama);
Depth-map of the room;
Plane description, geometry & mask, of background architecture (e.g. floor, walls, ceiling);
Instances mask and inflated instances mask;
Perceptual information such as semantic segmentation and lighting;

Empty-room assets (“Empty” in the FIG. 46)
Empty room inpainted image/panorama;
Pixelwise depth from layout;
Plane description, geometry & mask, of background architecture (e.g. floor, walls, ceiling);
Perceptual information such as semantic segmentation and lighting;

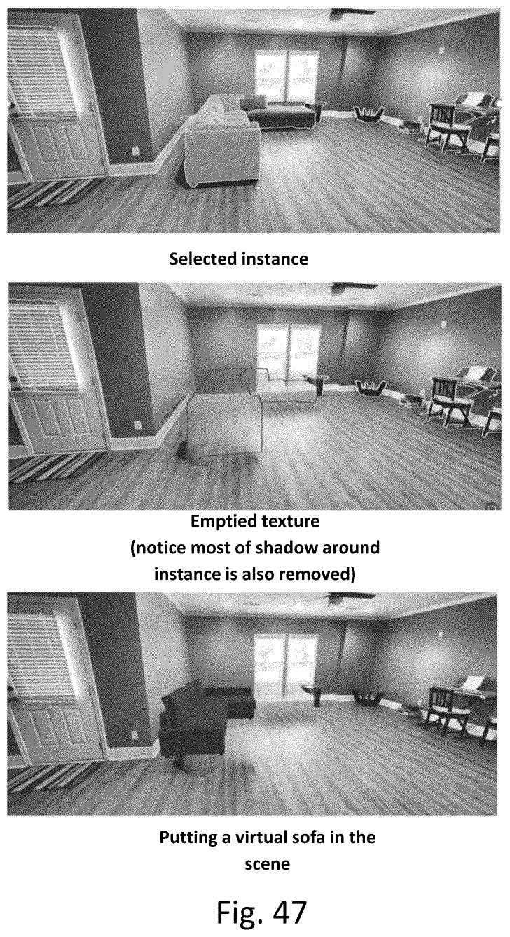

FIG. 47 illustrates an example of a furniture eraser feature interface according to an exemplary embodiment. The backend assets used for this feature can include the pixelwise depth (or other depth measurements) from the layout, the empty room inpainted image, the original rgb image, the original pixelwise depth, the instances mask, and/or the inflated instances mask.

The operation of the furniture eraser can include the following steps:
User goes into an ‘edit’ mode, where they see all selectable instances
User selects and clicks on one of the instances. The instance can then be removed from the scene. When the object is erased, the pixels corresponding to a dilated instance in the RGB image are replaced with the inpainted RGB image, and the depth image is replaced with the inpainted depth image.
The user can place virtual furniture in the place of the erased furniture

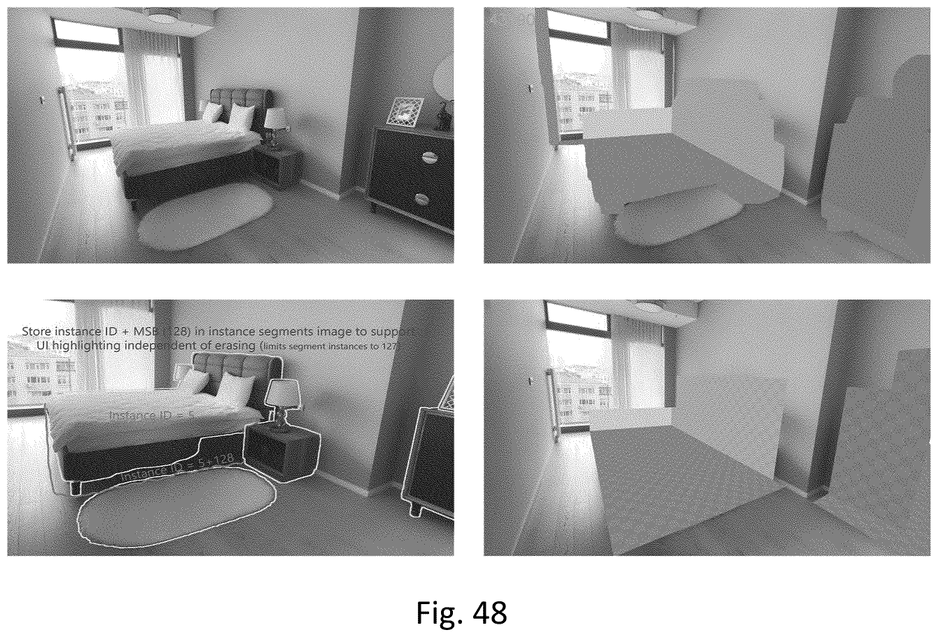

FIG. 48 illustrates an example of erasing Manhattan constraints instances according to an exemplary embodiment. The present system supports erasing Manhattan-constraints instances. This helps with the immersion factor as the original object's shape is no longer visible. This process includes:
For each segmented pixel, drop the unprojected depth down to the the floor plan, through the gravity vector.
Pull dropped depth forward during depth-test to prevent self-occlusion on mis-classified pixels.
Augment segment with dropped pixel region.

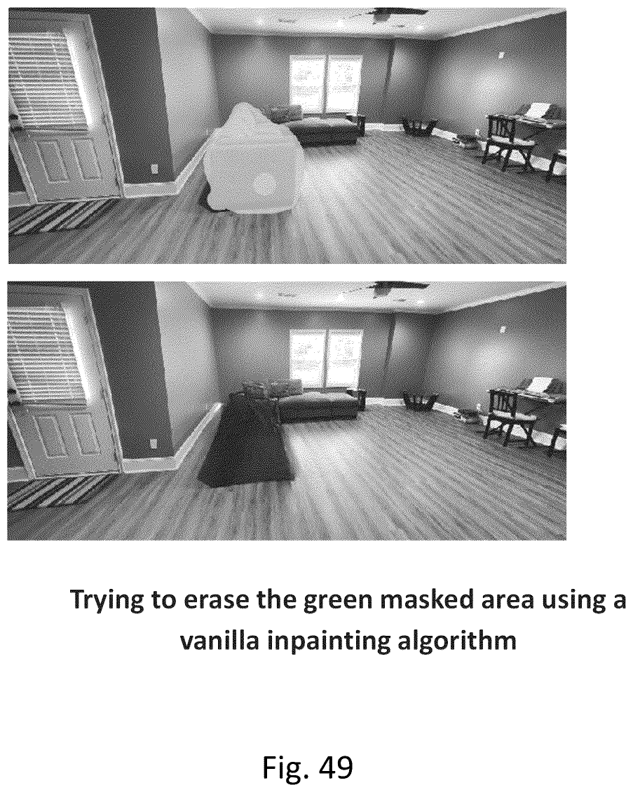

The present system can provide users an option to use a brush tool. FIG. 49 illustrates an example of a conventional brush tool. Existing methods use an algorithm to inpaint the masked area, which results in furniture and shadow smudging, if the mask is touching a furniture/shadow, as shown in FIG. 49.

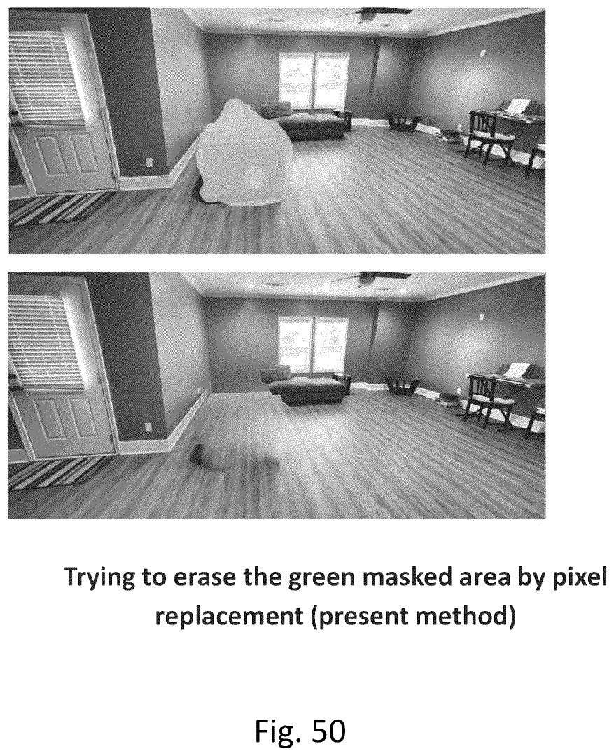

FIG. 50 illustrates an example of a brush tool according to an exemplary embodiment. The present system can use an “empty room image” created by the Furniture Eraser (FE) Engine as an initialization. A user can use a brush to mark out the area, which they want to erase, and the system can then replace the pixels of those area with empty room image.

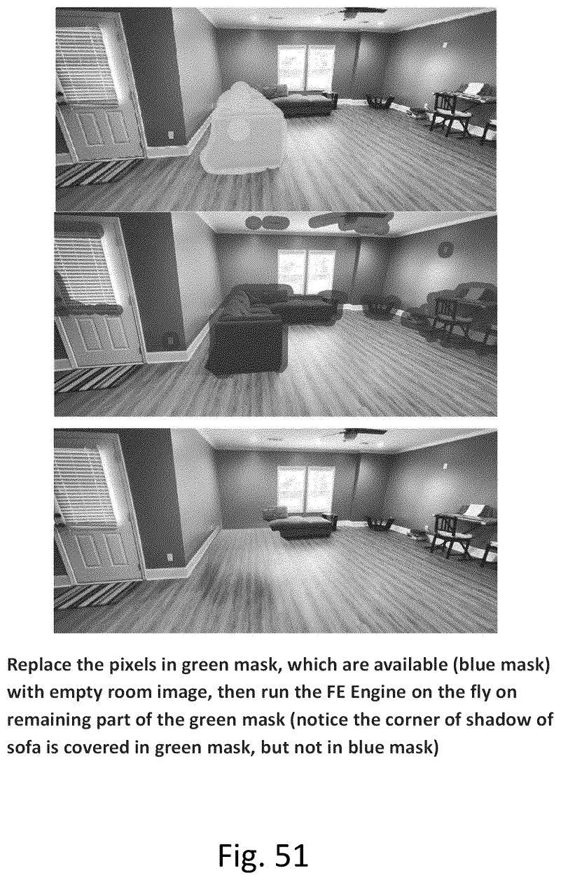

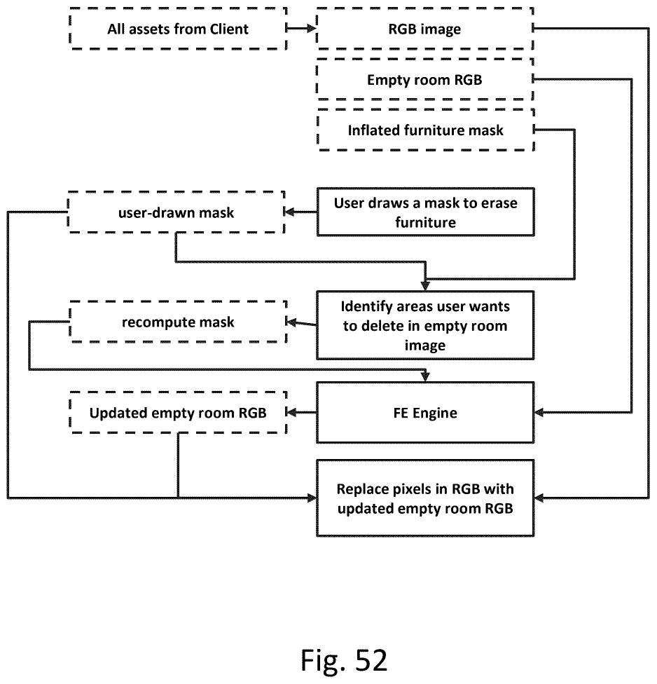

FIG. 51 illustrates another example of the application of the brush tool according to an exemplary embodiment. Additionally, FIG. 52 illustrates a user brush tool usage flowchart according to an exemplary embodiment.

A user with a brush can draw an erase area outside the inflated/dilated furniture mask. In that case, the system can identify the brush mask outside the furniture mask (referred to as a “recompute mask.”). The system applies the FE Engine on the recompute mask and empty room RGB image, and the output of the FE Engine is taken as the new empty room RGB, which can then be used to replace the masked pixels in the user interface and/or client.

In another scenario, a user might not like a shadow or some artifacts left behind in the emptied areas themselves. This intent can be identified by using a cue of a user drawing a mask in same area more than once. In this case, the recompute mask is equal to the entire user-drawn mask. The system applies the FE Engine on the recompute mask and the empty room RGB image, and the output of the FE Engine is taken as the new empty room RGB image, which can be used to replace the masked pixels in the user interface and/or client.

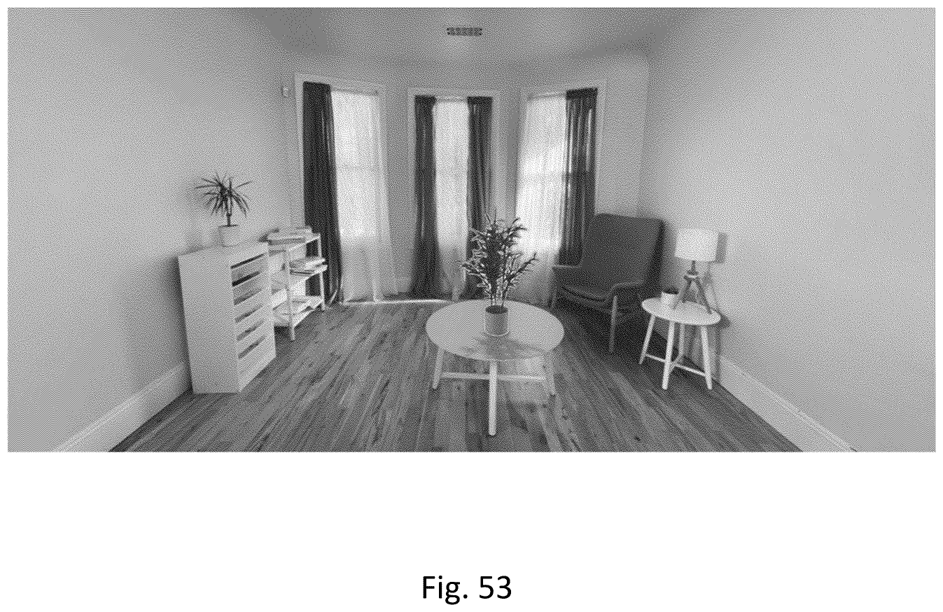

FIG. 53 illustrates an example of inpainting with stackable objects according to an exemplary embodiment. Stackables are objects that can be stacked on top of other objects (e.g. plants, candles). Stackables can be placed without any constraints on top of any furniture, and follow common physics laws. However, to offer a sensible decorating experience, the present system offers placeability on planar surfaces (i.e. “placeables”). Placeables and erasable furniture-items are associated via meta-data. Therefore, if a user places a plant (stackable) on top of a placeable (top plane of a table) and then later erases the table, the plant can be automatically removed or dropped on the floor.

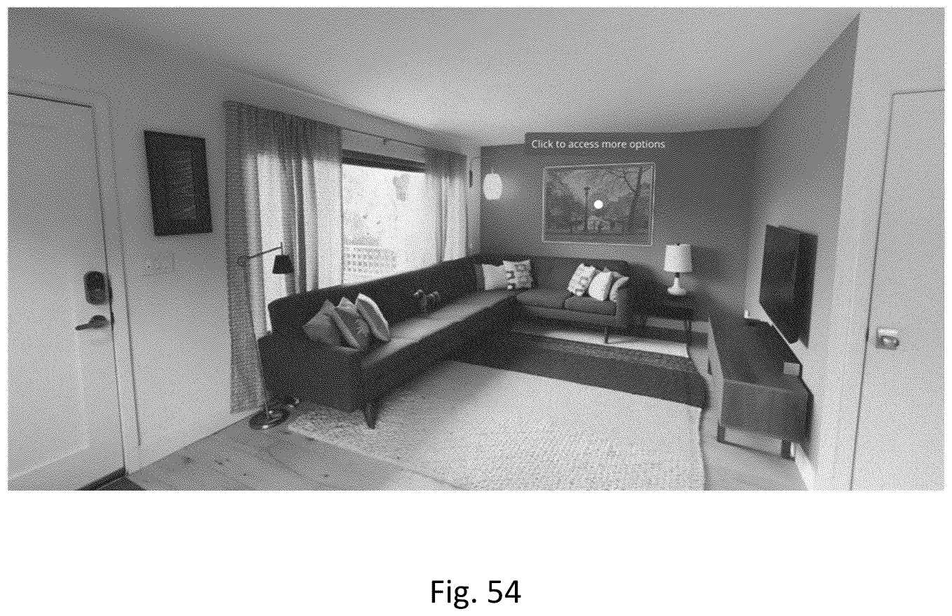

FIG. 54 illustrates an example of inpainting with wall decor according to an exemplary embodiment. Real-world rooms often have pictures/art placed on walls. The present system enables selection of existing real wall-decoration items, erasure of existing real wall-decoration items, and proper placement of new virtual wall-decoration items. The placement of new virtual items is seamless as the erased regions behind real items can be replaced on the fly by the “empty” version of the assets (e.g., the empty room with objects removed) described earlier.

Part of making the design experience more immersive consists in tackling lighting related effects on erased furniture. One major effect is shadows. The present system can associate furniture with their cast shadows, using perceptual cues (e.g. semantic segmentation) and 3D information. This can be performed with the following steps:
Given a set of estimated light sources parameters (including their number, type, position, intensity, color, size).
Generate a shadow map using scene light and geometry.
Analyze a neighboring region to each object to detect shadows.
Make the association between each object and shadow.

The present system is not limited to a single view or two dimensional images. In particular, the present system can utilize:
Multiple images (color information);
Multiple 3D images (color and geometry);
Multiple 3D images, with additional sensor data (e.g. IMU);
A textured 3D representation of the scene such as, meshes, voxels, CAD models, etc.

Multi-view can be incorporated in the refinement of the infilled geometry:
Objects, as viewed from multiple angles, will have more complete geometry.
Instead of replacing infilled geometry with the layout-geometry from layout planes, the present system can utilize foreground object geometries as well.

Multi-view can be incorporated in the refinement of the infilled texture:
(i) pairs of images where the loss can be described as ∥inpaint(im1)−project(inpaint(im2))∥
(ii) associated planes from two different view images where the loss can be described as loss=∥inpaint(plane_im1)−Homography (inpaint(plane_im2))∥

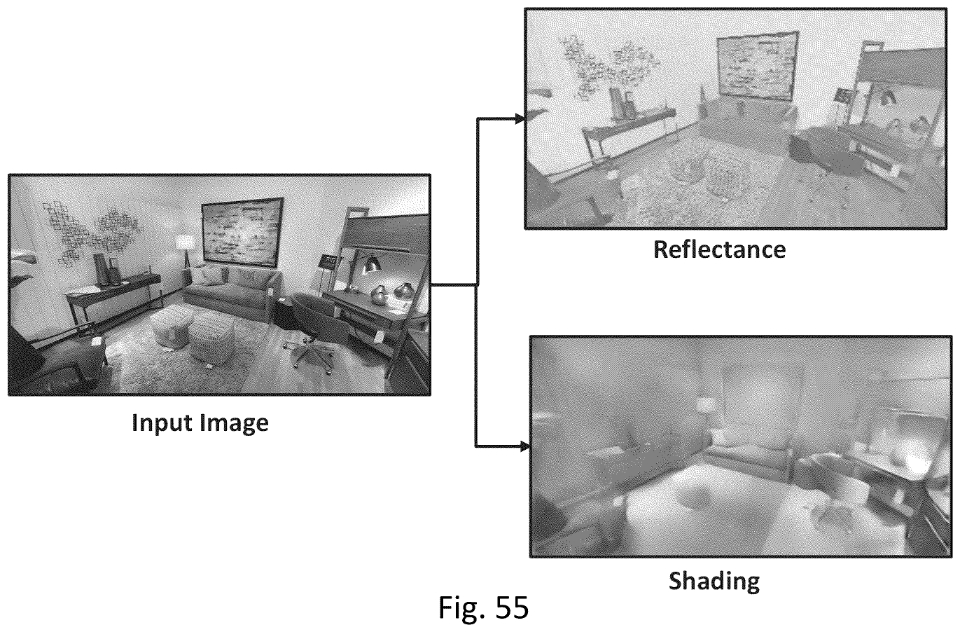

FIG. 55 illustrates an example of inpainting with intrinsic image decomposition according to an exemplary embodiment. Intrinsic Image Decomposition (IID) is the task of splitting an input image into a Reflectance (R) image and a Shading(S) image, which have following properties:
Reflectance is the image of ‘color’ of the scene, devoid of any shadows/lighting effects;
Shading is the image of ‘lighting’ of the scene, which would contain reflections, shadows, and lighting variations;
The input image is an element-wise product of reflectance and shading (in linear RGB space): I=R*S.

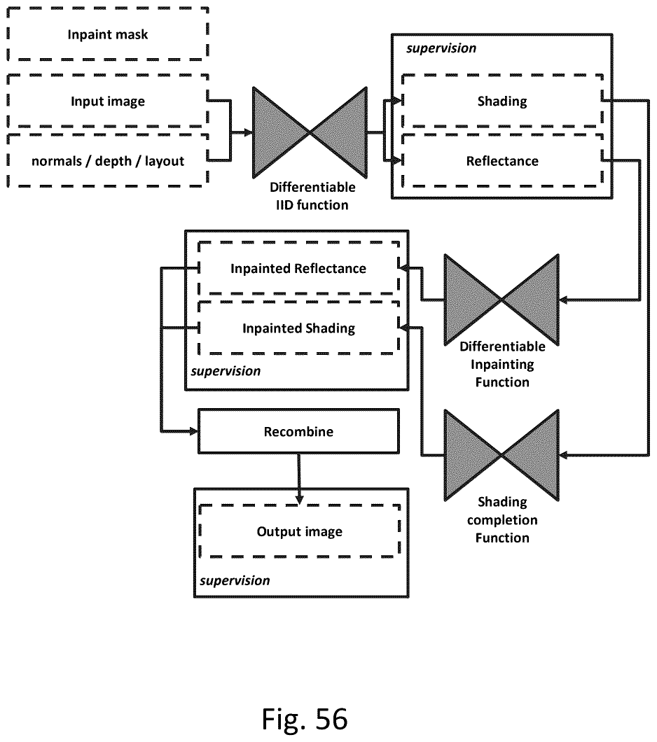

FIG. 56 illustrates a flowchart of inpainting with intrinsic image decomposition according to an exemplary embodiment. To avoid inpainting shadows into the erased areas, the present system can decompose the input image into reflectance and shading, inpaint them separately using separate differentiable functions, and then multiply the inpainted reflectance and shading images to get a final inpainted image. This ensures that the color inpaint isn't disturbed by shadows, and it also helps the system to inpaint the shadow using a separate specialized function (e.g. a neural network trained explicitly on inpainting shading images).

The entire system shown in FIG. 56 can be trained with one or more supervised losses. The outputs of the system, which can be supervised using training examples, are the shading and reflectance data, the inpainted shading and reflectance, and the output image.

In the multi-view/multi-image setting, when the feature refinement software (discussed earlier) is used with consistency loss between images from multiple views, the system can use only the reflectance channel, instead of the RGB image, because shading can change between different viewing directions, but reflectance is invariant against viewing direction.

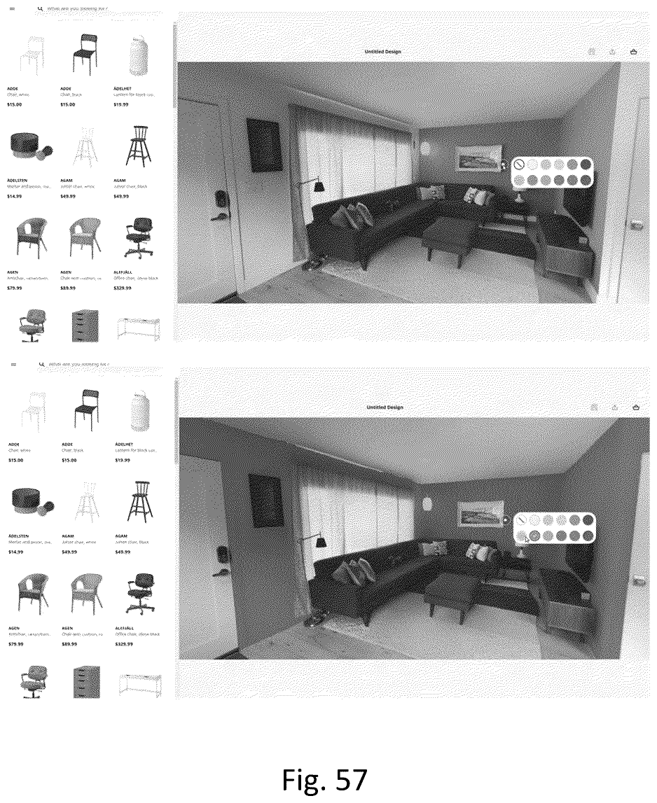

FIG. 57 illustrates an example of inpainting and background color editing according to an exemplary embodiment. To offer an immersive experience, the present platform also offers wall/floor/ceiling texture editing. In order to achieve a sensible interaction between the Furniture Eraser and Background Color Editing, reflectance and shading can be predicted (using IID or other similar techniques, as described previously) of the inpainted image.

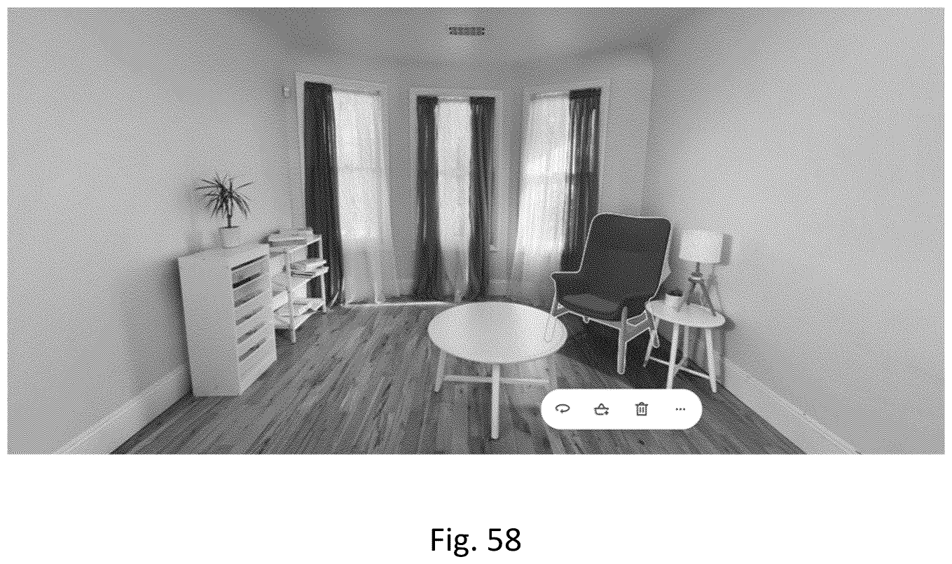

FIG. 58 illustrates an example of inpainting and auto-decoration according to an exemplary embodiment. Users may erase existing furniture to re-imagine their spaces with new virtual furniture and/or declutter their spaces.

There are situations where users may desire to move existing furniture in the scene to another location. To achieve this, the present system utilizes existing perceptual cues (e.g. instance segmentation) and 3D representation to generate proxy furniture that can be moved around the room. Three approaches are described below:
Approach #1—An electronic catalog of furniture items can be utilized to add proxy furniture. When a user selects an object to erase, the system uses a visual similarity search to recover the closest model available (geometry & texture) to the erased real one. The system can then add it automatically to the user's design. The new model functions as proxy furniture and can be moved freely within the room. A simple version of this approach can utilize a basic bounding box corresponding to the erased-object. The simple version can be utilized, for example, when a similar object cannot be located in the catalog.
Approach #2—A shape-completion algorithm or neural network takes the image of the object to erase, and optionally other perceptual and/or geometric information, and estimates 3D proxy objects that could most probably match the image of the object to be erased.
Approach #3—When a user selects an object to erase, its background is infilled/inpainted using the Furniture Eraser Engine. The system can then make the removed geometry & texture available to be placed anywhere within the scene (e.g., as a sticker, billboard “imposter,” or a depth sprite).

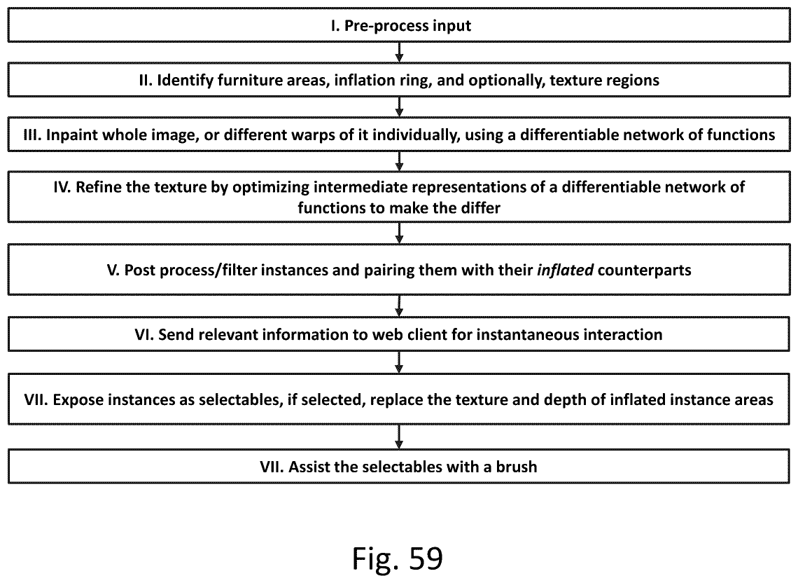

FIG. 59 illustrates a high level flowchart for a client brush tool incorporating the described foreground object deletion and inpainting methods according to an exemplary embodiment. As shown in the figure, the steps include:
I. Pre-processing input;
II. Identifying furniture areas, inflation ring, and optionally, texture regions;
III. Inpainting the whole image, or different warped/transformed versions of it individually, using a differentiable network of functions;
IV. Refining the texture by optimizing intermediate representations of a differentiable network of functions;
V. Post processing/filtering instances and pairing them with their inflated counterparts;
VI. Sending relevant information to web client for instantaneous interaction;
VII. Exposing instances as selectables, and, if selected, replace the texture and depth of inflated instance areas; and
VII. Assisting the selectables with a brush.

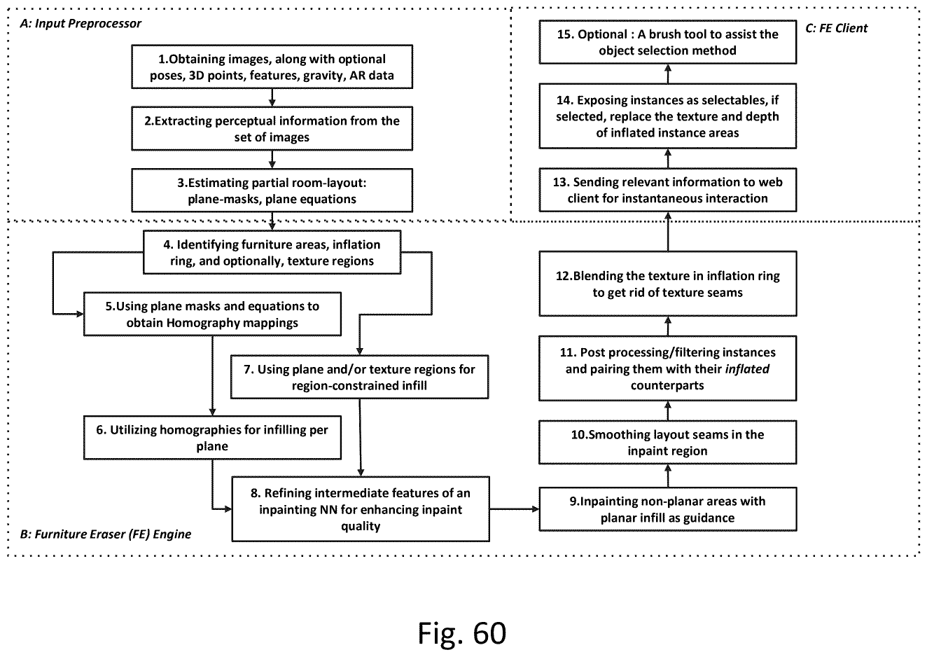

FIG. 60 illustrates a high level flowchart for foreground object deletion and inpainting according to an exemplary embodiment. Each of the steps in the flowchart of FIG. 60 is described in greater detail below.

A.1: A user obtains one or more images with optional gravity, camera poses, 3D points or depthmaps, features, AR data. A user obtains one RGBD, or more than 1 RGB/RGB+IMU/RGBD images of a room/space with optional measurement of gravity vector. Any 3D representation of the capture scene (e.g. point clouds, depth-maps, meshes, voxels, where 3D points are assigned their respective texture/color) can also be used.

A.2: The captures are used to obtain perceptual quantities/contextual information, aligned to one or more of the input images, individually or stitched into composite images. These perceptual quantities include semantic segmentation, instance segmentation, line segments, edge-map, and dense depth. The dense depth can be obtained by using dense fusion on RGBD, or by densifying sparse reconstruction from RGB images. Metric scale can be estimated using many methods including multi-lens baseline, active depth sensor, visual-inertial odometry, SLAM points, known object detection, learned depth or scale estimation, manual input, or other methods.

A.3: A layout estimation system utilizes the perceptual information to identify one or more of the wall, floor, and ceiling planes. The output of the system is a plane-mask aligned to the image of interest, along with the 3D equation for each of the plane.

B.4: The system can take a union of all the instances (i.e., detected objects), along with semantic segmentation classes, like sofa, chair, etc. to create a furniture mask, which can then processed to create an inflation/dilation ring. Texture regions are created by splitting the image into regions, using lines, planes, and semantic segmentation.

B.5: For each plane, the system calculates a set of one or more homographies, using the plane equations. These homographies are used to rectify the plane pixels to fronto-parallel view.

B.6: The system maintains a texture buffer, and a binary “filling” buffer. For each plane, the system rectifies it, infills the masked area, and then inverse-rectifies the infilled pixels to create a texture image. All the masked pixels which are free of interpolation artifacts in this texture image, and are 0s in the filling buffer, are pasted into the texture buffer. Filling buffer is updated with 1s for all the interpolation-free pixels.

B.7: Another way of infilling is to do it in the perspective view instead of in the per-plane manner. The system can do it by ensuring that the infilled texture is sampled from the same texture region, using the texture regions mask. When using a Deep Neural Network (DNN) based technique, the system can train a network with an additional sampling mask, and then, during run-time, the system can pass a sampling mask for each texture-region, or sampling mask for each plane.

B.8: The system utilizes a novel refinement scheme, which optimizes features of an intermediate layer of an inpainting neural network, on certain losses. These losses can be histogram loss (to ensure that infilled color is same as source pixels color), multi-scale loss (ensures infill at smaller resolution is same as that at higher), etc.

B.9: There can be some areas of the image which aren't covered in any plane region or texture region. These areas can be inpainted with guidance from the previously inpainted regions, i.e., the system can use the texture buffer itself as an input image, and the mask as the masked pixels in the remaining area. The mask can then be infilled using a variety of different infill/inpainting algorithms, as described herein.

B.10: As the system utilizes inpainting with plane regions constraints, the boundaries between planes (wall-wall, or wall-floor) could appear jagged. The system performs some smoothing in the masked areas along these seams, to make the layout appear more realistic.

B.11: The system performs some filtering on the object instance masks (post-processing for things like fusing tidbits with bigger instances, ensuring instance pixels are mutually exclusive, etc.). Following this, instances are inflated into the inflated inpaint mask, while maintaining mutual exclusivity. Inflating instances to match the inflated inpaint mask enables seamless textures when a furniture item is removed.

B.12: Sometimes, the texture that is inpainted is discontinuous with respect to the remaining image. In this case, the system performs a blending of the textures of the remaining image and masked area, in the area marked by the inflation ring. After this, the system gets a final RGB image with all the furniture removed, i.e., an empty room RGB image.

C.13: When the system is implemented in a server-client framework, a number of assets/data structures can be passed to a client (web/mobile) to enable the furniture eraser feature for the user. These include, and are not limited to: the RGB image, an empty room RGB image, a dense depth image, an empty room dense depth image (using the layout planes), a single mask containing flattened object instances, and/or a single mask containing inflated object instances.

C.14: For ease of design, the system enables customers to click on semantic “objects” to erase, instead of having a tedious “brush tool” for removal. This tool enables the customer to erase any furniture item instantaneously, and then allows the customer to click on the instance again to make it reappear. The system does not have to store a log of multiple images to facilitate an undo operation.

C.15: The system also provides the user an option to use a brush tool instead of select and erase instances. The brush can support a fusion of instantaneous and on-the-fly inpainting, depending on the region that is selected for object removal.

The geometry determination and inpainting techniques described herein can be used for estimating the geometry of an entire room and an inpainting multiple surfaces of the room.

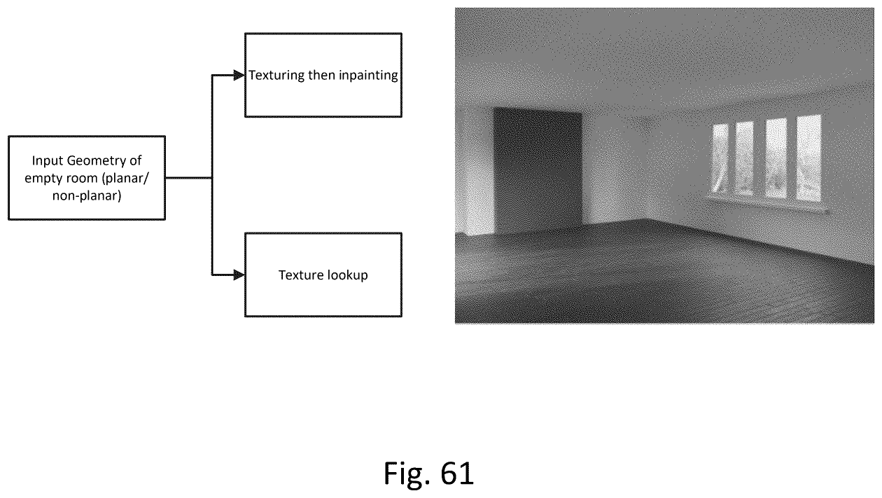

FIG. 61 illustrates a flowchart for inpainting a room according to an exemplary embodiment. The process takes as input the geometry of the empty room. This can be determined based on the extracted layout information and optionally, the texture regions, as discussed previously. The geometry of the room can include planes and plane masks, but can also include non-planar geometry, such as curved surfaces (e.g., walls, ceilings, or floors).

As shown in FIG. 61, there are two approaches that can be utilized by the system to inpaint the room geometry. The first approach is texturing and then inpainting and the second approach is texture lookup. Each of these approaches uses inpainting to fill in textures within the room that are not visible from the images used to determine the room geometry is described below.

Texturing and then Inpainting:
For each point on the 3D geometry, the system finds the frame in an RGB video/pan of the room, which views the point in a fronto-parallel fashion. It is then mapped onto the geometry to produce a textured mesh. This is done using a texture mapping system.
After this the system extracts semantic segmentation for each of the frames of the video, to identify foreground and background. Then the system uses the same mapping from the previous step, to build a semantic map on the geometry.
Each plane is then inpainted using the techniques described herein, to produce an empty room image.

### Texture Lookup:

For each semantic element in the scene, the system can look up a similar material/texture to the texture to be inpainted in a material/texture bank or electronic catalog that stores materials/textures. A similar material/texture can be retrieved based on the visual appearance of a texture, a semantic label assigned to the plane or texture (e.g., hardwood floor), or other contextual information relating to the plane or texture.
Contextual information, such as lights or other environmental factors, can be added to the scene and used to generate photographic quality renderings and images.
The result is a synthetic shell of the room that utilizes the room geometry but relies on a texture/material bank to fill the layout planes and other layout geometry of the room. FIG. 61 also illustrates an example of the synthetic shell of a room generated by estimating layout and using a texture bank to fill in the layout planes with appropriate textures.

The present system for foreground object deletion and inpainting produces superior results to existing inpainting techniques. To quantify inpainting quality, a measure called incoherence can be utilized.

To calculate incoherence, the edge-probability map is first extracted for both the ground-truth and the predicted image. All the pixels in the predicted image, for which the corresponding pixel is an edge in the ground-truth image, are suppressed to 0. Incoherence is then the average of edge probabilities across all the pixels in the predicted image. A higher incoherence can therefore be associated with more, or stronger, false edges in the inpainting.

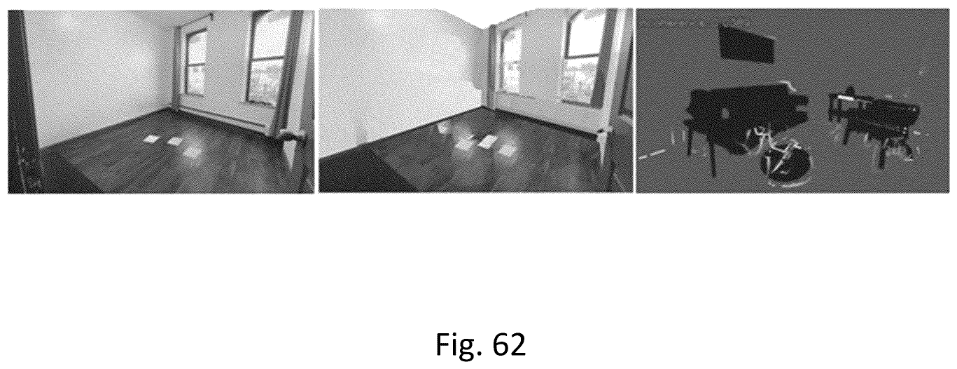

FIG. 62 illustrates an example of incoherence introduced by inpainting according to an exemplary embodiment. FIG. 62 shows, from left to right, a ground-truth image, an inpainted image, and an incoherence map. The green/black colors are for unmasked/masked regions, and the white color shows the incoherence introduced by the inpainting.

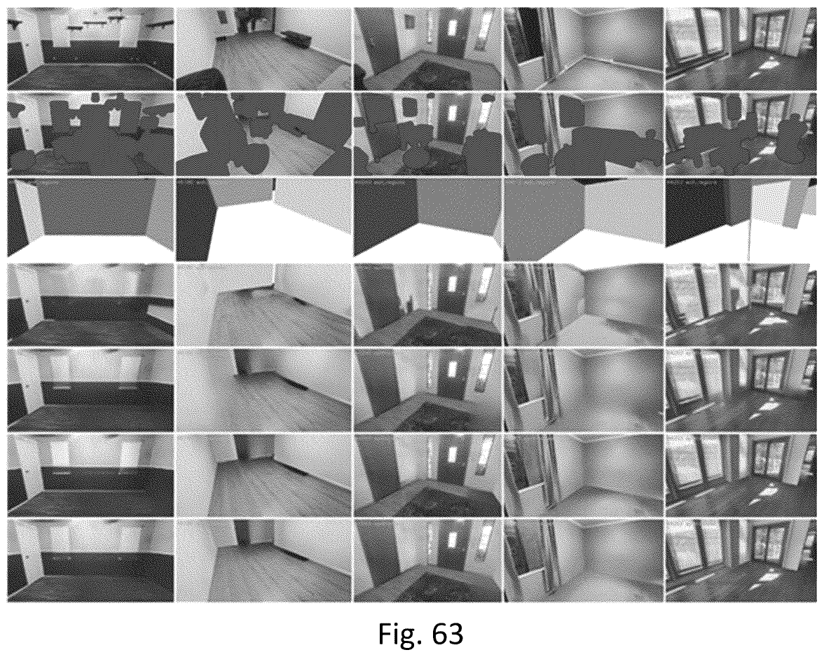

FIG. 63 illustrates qualitative examples from an inpainting test set according to an exemplary embodiment. Each column shows a single example over multiple methods. The top three rows are ground-truth image, masked input image, and the detected layout, respectively. From the fourth to sixth row are previous inpainting methods (Previous Methods 1-3). The seventh row illustrates inpainting using the techniques disclosed herein.

Computing incoherence for the inpainting techniques shown in FIG. 63 results in the following table:

| | Incoherence↓ |
|---|---|
| Previous Method 1 | 0.0203 |
| Previous Method 2 | 0.0121 |
| Previous Method 3 | 0.0063 |
| Present Solution | 0.0036 |

As shown above, the present system produces higher quality inpainting results, as measured by incoherence, and as shown qualitatively in FIG. 63.

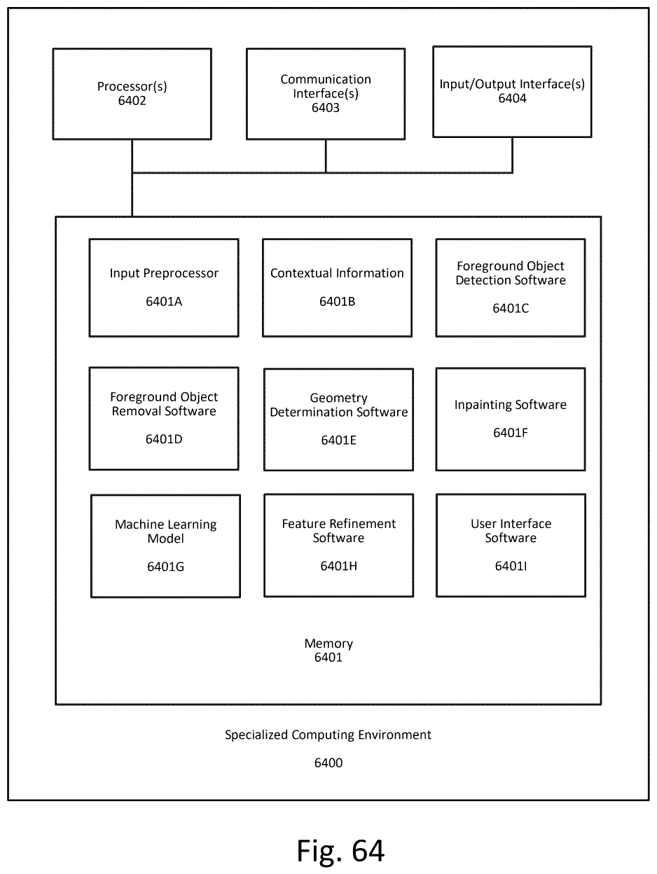

FIG. 64 illustrates the components of a specialized computing environment 6400 configured to perform the processes described herein according to an exemplary embodiment. Specialized computing environment 6400 is a computing device that includes a memory 6401 that is a non-transitory computer-readable medium and can be volatile memory (e.g., registers, cache, RAM), non-volatile memory (e.g., ROM, EEPROM, flash memory, etc.), or some combination of the two.

As shown in FIG. 64, memory 6401 can include input preprocessor 6401A, contextual information 6401B, foreground object detection software 6401C, foreground object removal software 6401D, geometry determination software 6401E, inpainting software 6401F, machine learning model 6401G, feature refinement software 6401H, and user interface software 6401I.

Each of the program and software components in memory 6401 store specialized instructions and data structures configured to perform the corresponding functionality and techniques described herein.

All of the software stored within memory 6401 can be stored as a computer-readable instructions, that when executed by one or more processors 6402, cause the processors to perform the functionality described with respect to FIGS. 3A-63.

Processor(s) 6402 execute computer-executable instructions and can be a real or virtual processors. In a multi-processing system, multiple processors or multicore processors can be used to execute computer-executable instructions to increase processing power and/or to execute certain software in parallel.

Specialized computing environment 6400 additionally includes a communication interface 6403, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 6400 further includes input and output interfaces 6404 that allow users (such as system administrators) to provide input to the system to display information, to edit data stored in memory 6401, or to perform other administrative functions.

An interconnection mechanism (shown as a solid line in FIG. 64), such as a bus, controller, or network interconnects the components of the specialized computing environment 6400.

Input and output interfaces 6404 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 6400.

Specialized computing environment 6400 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 6400.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method executed by one or more computing devices for foreground object deletion and inpainting, the method comprising:
storing contextual information corresponding to an image of a scene, the contextual information comprising depth information corresponding to a plurality of pixels in the image and a semantic map indicating semantic labels associated with the plurality of pixels in the image;
identifying one or more foreground objects in the scene based at least in part on the contextual information, each foreground object having a corresponding object mask;
identifying at least one foreground object in the one or more foreground objects for removal from the image;
generating a removal mask corresponding to the at least one foreground object based at least in part on at least one object mask corresponding to the at least one foreground object;
determining an estimated geometry of the scene behind the at least one foreground object based at least in part on the contextual information; and
inpainting pixels corresponding to the removal mask with a replacement texture omitting the at least one foreground object based at least in part on the estimated geometry of the scene behind the at least one foreground object.

2. The method of claim 1, wherein the contextual information further comprises one or more of:
a gravity vector corresponding to the scene;
an edge map corresponding to a plurality of edges in the scene;
a shadow mask corresponding to a plurality of shadows in the scene;
a normal map corresponding to a plurality of normals in the scene;
an instance map indicating a plurality of instance labels associated with the plurality of pixels in the image; or
a plurality of object masks corresponding to a plurality of objects in the scene.

3. The method of claim 1, wherein the depth information corresponding to the plurality of pixels in the image comprises one of:
a dense depth map corresponding to the plurality of pixels;
a sparse depth map corresponding to the plurality of pixels;
a plurality of depth pixels storing both color information and depth information;
a mesh representation corresponding to the plurality of pixels;
a voxel representation corresponding to the plurality of pixels;
depth information associated with one or more polygons corresponding to the plurality of pixels; or
three-dimensional geometry information corresponding to the plurality of pixels.

4. The method of claim 1, wherein the semantic labels comprise one or more of:
floor, wall, table, desk, window, curtain, ceiling, chair, sofa, furniture, light fixture, or lamp.

5. The method of claim 1, wherein identifying one or more foreground objects in the scene based at least in part on the contextual information comprises:
identifying a plurality of object pixels corresponding to an object in the scene;
identifying one or more semantic labels corresponding to the plurality of object pixels; and
classifying the object as either a foreground object or a background object based at least in part on the identified one or more semantic labels.

6. The method of claim 1, wherein identifying at least one foreground object in the one or more foreground objects for removal from the image comprises:
receiving a selection from a user of the at least one foreground object in the one or more foreground objects for removal from the image.

7. The method of claim 1, wherein identifying at least one foreground object in the one or more foreground objects for removal from the image comprises:
identifying all foreground objects in the one or more foreground objects for removal from the image.

8. The method of claim 7, wherein generating a removal mask corresponding to the at least one foreground object based at least in part on the at least one object mask corresponding to the at least one foreground object comprises:
generating a furniture mask corresponding to all foreground objects in the one or more foreground objects by combining one or more object masks corresponding to the one or more foreground objects.

9. The method of claim 1, wherein the one or more foreground objects comprise a plurality of foreground objects and wherein identifying at least one foreground object in the one or more foreground objects for removal from the image comprises:
combining two or more foreground objects in the plurality of foreground objects into a compound foreground object based at least in part on one or more of: proximity between pixels corresponding to the two or more foreground objects, overlap between pixels corresponding to the two or more foreground objects, or semantic labels corresponding to the two or more foreground objects, wherein the compound foreground object comprises a compound object mask; and
identifying the compound foreground object for removal from the image.

10. The method of claim 9, wherein generating a removal mask corresponding to the at least one foreground object based at least in part on the at least one object mask corresponding to the at least one foreground object comprises:
combining two or more object masks corresponding to the two or more foreground objects into a compound object mask.

11. The method of claim 1, wherein the contextual information comprises a shadow mask and wherein generating a removal mask corresponding to the at least one foreground object based at least in part on at least one object mask corresponding to the at least one foreground object comprises:
combining at least a portion of the shadow mask with the at least one object mask corresponding to the at least one foreground object.

12. The method of claim 1, wherein generating a removal mask corresponding to the at least one foreground object based at least in part on at least one object mask corresponding to the at least one foreground object comprises:
dilating the at least one object mask corresponding to the at least one foreground object by a predetermined quantity of pixels to thereby inflate the at least one object mask.

13. The method of claim 12, wherein the contextual information comprises a shadow mask and wherein generating a removal mask corresponding to the at least one foreground object based at least in part on at least one object mask corresponding to the at least one foreground object further comprises:
combining at least a portion of the shadow mask with the dilated at least one object mask corresponding to the at least one foreground object.

14. The method of claim 1, wherein generating a removal mask corresponding to the at least one foreground object based at least in part on at least one object mask corresponding to the at least one foreground object comprises:
modifying the at least one object mask corresponding to the at least one foreground object based at least in part on the contextual information.

15. The method of claim 1, wherein determining an estimated geometry of the scene behind the at least one foreground object based at least in part on the contextual information comprises:
identifying a plurality of planes corresponding to a plurality of background objects in the scene based at least in part on the depth information and the semantic map;
storing a plurality of plane equations corresponding to the plurality of planes and a plurality of plane masks corresponding to the plurality of planes, wherein each plane mask indicates the presence or absence of a particular plane at a plurality of pixel locations;
determining one or more planes behind the at least one foreground object based at least in part on the plurality of plane masks and a location of the at least one foreground object; and
determining an estimated geometry of the one or more planes behind the at least one foreground object based at least in part on one or more plane equations corresponding to the one or more planes.

16. The method of claim 1, wherein the estimated geometry comprises one or more planes and wherein inpainting pixels corresponding to the removal mask with a replacement texture omitting the at least one foreground object based at least in part on the estimated geometry of the scene behind the at least one foreground object comprises, for each plane in the one or more planes:
inpainting a set of pixels corresponding to at least a portion of the removal mask that overlaps the plane; and
adjusting depth information for at least a portion of the inpainted pixels based at least in part on depth information corresponding to the plane.

17. The method of claim 16, further comprising, for each plane in the one or more planes:
updating semantic labels associated with the inpainted pixels based at least in part on semantic labels associated with the plane.

18. The method of claim 16, wherein inpainting pixels corresponding to the removal mask with a replacement texture omitting the at least one foreground object based at least in part on the estimated geometry of the scene behind the at least one foreground object further comprises, for each plane in the one or more planes:
performing a homography to warp pixels of the plane from an original viewpoint into a fronto-parallel plane prior to inpainting the set of pixels; and
performing a reverse homography to warp the pixels of the plane back to the original viewpoint subsequent to inpainting the set of pixels.

19. The method of claim 1, wherein inpainting pixels corresponding to the removal mask with a replacement texture omitting the at least one foreground object based at least in part on the estimated geometry of the scene behind the at least one foreground object comprises:
performing a transformation to warp pixels corresponding to the estimated geometry from an original viewpoint into a frontal viewpoint prior to inpainting the set of pixels;
performing a reverse transformation to warp the pixels of the estimated geometry back to the original viewpoint subsequent to inpainting the set of pixels.

20. The method of claim 16, wherein inpainting a set of pixels corresponding to at least a portion of the removal mask that overlaps the plane comprises:
extracting one or more texture regions from the plane based at least in part on a plane mask corresponding to the plane, the plane mask indicating the presence or absence of that plane at a plurality of pixel locations; and
inpainting the set of pixels based at least in part on the one or more texture regions.

21. The method of claim 16, wherein inpainting a set of pixels corresponding to at least a portion of the removal mask that overlaps the plane comprises:
inpainting the set of pixels with a pattern.

22. The method of claim 16, wherein inpainting a set of pixels corresponding to at least a portion of the removal mask that overlaps the plane comprises:
inpainting the set of pixels with a texture retrieved from an electronic texture bank.

23. The method of claim 16, wherein inpainting a set of pixels corresponding to at least a portion of the removal mask that overlaps the plane comprises:
inpainting the set of pixels with a neural-network produced texture that is generated based at least in part on one or more textures corresponding to one or more background objects in the image.

24. The method of claim 23, wherein the neural network is configured to refine the texture based at least in part on a multi-scale loss for images at multiple scales and a histogram loss between histograms extracted for the images at multiple scales.

25. An apparatus for foreground object deletion and inpainting, the apparatus comprising:
one or more processors; and
one or more memories operatively coupled to at least one of the one or more processors and having instructions stored thereon that, when executed by at least one of the one or more processors, cause at least one of the one or more processors:
store contextual information corresponding to an image of a scene, the contextual information comprising depth information corresponding to a plurality of pixels in the image and a semantic map indicating semantic labels associated with the plurality of pixels in the image;
identify one or more foreground objects in the scene based at least in part on the contextual information, each foreground object having a corresponding object mask;
identify at least one foreground object in the one or more foreground objects for removal from the image;
generate a removal mask corresponding to the at least one foreground object based at least in part on at least one object mask corresponding to the at least one foreground object;
determine an estimated geometry of the scene behind the at least one foreground object based at least in part on the contextual information; and
inpaint pixels corresponding to the removal mask with a replacement texture omitting the at least one foreground object based at least in part on the estimated geometry of the scene behind the at least one foreground object.

26. At least one non-transitory computer-readable medium storing computer-readable instructions for foreground object deletion and inpainting that, when executed by one or more computing devices, cause at least one of the one or more computing devices to:
store contextual information corresponding to an image of a scene, the contextual information comprising depth information corresponding to a plurality of pixels in the image and a semantic map indicating semantic labels associated with the plurality of pixels in the image;
identify one or more foreground objects in the scene based at least in part on the contextual information, each foreground object having a corresponding object mask;
identify at least one foreground object in the one or more foreground objects for removal from the image;
generate a removal mask corresponding to the at least one foreground object based at least in part on at least one object mask corresponding to the at least one foreground object;
determine an estimated geometry of the scene behind the at least one foreground object based at least in part on the contextual information; and
inpaint pixels corresponding to the removal mask with a replacement texture omitting the at least one foreground object based at least in part on the estimated geometry of the scene behind the at least one foreground object.
